(19) United States
(12) Patent Application Publication
(10) Pub. No.: US 2026/0357823 A1
(43) Pub. Date: Nov. 12, 2026

(54) REDUCED MIXING PRESSURE EXCHANGER

(71) Applicant: Energy Recovery, Inc., San Leandro, CA (US)

(72) Inventors: Omprakash Samudrala, San Ramon, CA (US); Azam Mihir Thatte, Kensington, CA (US); Dung Le Tran, Castro Valley, CA (US); Michael Kjelson, Dallas, TX (US); Alexander Patrick Theodossiou, Alameda, VA (US); Matthew Joseph Pattom, Fremont, CA (US); Farshad Ghasripoor, Oakland, CA (US)

(21) Appl. No.: 19/748,024

(22) Filed: Jul. 20, 2026

Related U.S. Application Data
(62) Division of application No. 17/858,936, filed on Jul. 6, 2022.
(60) Provisional application No. 63/219,767, filed on Jul. 8, 2021.

(51) Int. Cl. F04F 13/00

(52) U.S. Cl. CPC F04F 13/00

(57) ABSTRACT

A pressure exchanger includes a rotor, floating piston, and constraint structures. The rotor forms a duct between duct openings. The pressure exchanger directs first fluid to a first duct opening and second fluid to a second duct opening. The floating piston is configured to form a barrier within the duct to prevent mixing of the first and second fluids and to cause pressure exchange between the first and second fluids. The floating piston includes an axially symmetric structure configured to axially slide within the duct. The constraint structures are disposed proximate the duct openings and are configured to prevent the floating piston from exiting the duct. At least one of the constraint structures is: press fit in the duct; shrunk fit in the duct; or restrained in the duct between corresponding retaining rings or between a corresponding retaining ring and a corresponding duct sidewall of the rotor.

### RELATED APPLICATIONS

This application is a divisional application of U.S. patent application Ser. No. 17/858,936, filed Jul. 6, 2022, which claims the benefit of Provisional Application No. 63,219,767, filed Jul. 8, 2021, the contents of which are hereby incorporated by reference in their entirety.

### TECHNICAL FIELD

Some embodiments of the present disclosure relate, in general, to a pressure exchanger with reduced mixing.

### BACKGROUND

Systems use fluids at different pressures. Pumps may be used to increase pressure of fluids used by systems.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-D illustrate schematic diagrams of fluid handling systems including hydraulic energy transfer systems, according to certain embodiments.

FIGS. 2-6 are exploded perspective views of rotary pressure exchangers (PXs) or rotary liquid piston compressors (LPCs), according to certain embodiments.

FIGS. 7A-H illustrate components associated with pressure exchangers, according to certain embodiments.

FIG. 8A-J illustrate floating pistons, according to certain embodiments.

FIG. 9A-B components of a PX (or LPC) with an elastic moveable barrier, according to certain embodiments.

FIG. 10 illustrates a reciprocating dual-piston structure disposed within a duct of a PX (or LPC), according to certain embodiments.

FIG. 11A-B illustrate PXs (or LPCs) including a hydraulic braking apparatus, according to some embodiments.

FIG. 12A-B are perspective views of a PX (or LPC) including hydraulic vanes, according to certain embodiments.

FIG. 13 illustrates a schematic diagram of a system using a reduced mixing pressure exchanger, according to certain embodiments.

FIGS. 14A-C illustrate fluid handling systems, according to certain embodiments.

FIG. 15 is a block diagram illustrating a computer system, according to certain embodiments

### DETAILED DESCRIPTION OF EMBODIMENTS

Embodiments described herein are related to a reduced mixing pressure exchangers (e.g., hydraulic energy transfer systems).

Systems may use fluids at different pressures. These systems may include hydraulic fracturing (e.g., fracking or fracing) systems, desalinization systems, refrigeration systems, mud pumping systems, slurry pumping systems, industrial fluid systems, waste fluid systems, fluid transportation systems, etc. Pumps may be used to increase pressure of fluid to be used by systems.

Some conventional systems use pumps to raise the head (pressure) of a fluid containing solid particles (e.g., particle-laden fluid, a slurry fluid), chemicals, and/or that has a viscosity that meets a threshold value. Conventionally, the solid particles (e.g., sand, powder, debris, ceramics, etc.), chemicals, and/or viscosity damage and reduce efficiency of pumps over time. Conventional systems then undergo more downtime so that pumps can undergo maintenance, repair, and replacement.

Some conventional systems use specialized pumps that have large clearances, may use costly exotic or hardened materials, and/or may be rubber-lined to reduce damage caused by the solid particles (e.g., abrasives), chemicals, and/or viscosity associated with the fluid. These pumps may be inefficient, requiring multiple pumps to be used in series to attempt to provide the desired head (pressure). These pumps still undergo abrasion and erosion. These pumps used in conventional systems may have an increased cost for materials, added manufacturing complexities, and decrease in overall system efficiencies. Erosion and/or abrasion in a pump reduces life, reduces efficiency, increases leakage, increases service intervals, increases replacement of parts, and reduces yield (e.g., of desalinization, fracing, refrigeration, slurry pumping), etc.

Pressure transfer systems may be used in some applications. Many industrial processes operate at an elevated pressure and have high-pressure waste streams. One way of providing a high pressure to operations requiring elevated pressure is to transfer pressure from a high-pressure fluid (e.g., high-pressure waste fluid) to a usable fluid for the high-pressure operations (e.g., frac fluid). A particular efficient type of pressure exchange is a rotary pressure exchanger. A rotary pressure exchanger uses a cylindrical rotor with longitudinal ducts aligned parallel to the rotational axis. The rotor spins inside a sleeve enclosed by two end covers. Pressure energy is transferred directly from the high-pressure stream to the low-pressure stream in the channels of the rotor. Some fluid that remains in the channels can serve as a barrier that prevents mixing between the streams. The channels of the rotor charge and discharge as the pressure transfer process repeats itself.

Conventional pressure exchangers (e.g., rotary pressure exchangers) result in some cross-contamination of species (e.g., first fluid and second fluid) across which the pressure energy is being exchanged. This cross-contamination is undesirable in some applications. As a result of this undesirable cross-contamination, conventional rotary pressure exchanging systems are precluded from various industrial applications or result in significant performance loss. For example, in fracking or desalination, the contamination of species can result in a reduction in the operational efficiency of a pressure exchanger. In an amine based natural gas processing plant, pressure exchange between “rich” amine and “lean” amine using a conventional pressure exchanger is not possible due to the presence of corrosive hydrogen sulfide (H2S) in the “rich” amine. In some conventional pressure exchangers, pressure and flow rate combinations of pressure exchanging fluids can be adjusted to minimize (e.g., prevent) the mixing of the fluids, however, there still exists a level of cross-contamination that occurs within a contact region between the fluids. The cross-contamination of species of a pressure exchange may result in quicker wearing of parts than in systems that have less fluid mixing. Part upkeep (e.g., repairs, replacements, etc.) and reduced pressure exchange efficiency, and other effects of species mixing within the pressure exchange can be mitigated by reducing (e.g., preventing) the amount of mixing that occurs between the fluids.

The devices and systems disclosed herein provide a hydraulic energy transfer system (e.g., rotary isobaric pressure exchanger (IPX)) that is configured to mitigate (e.g., to prevent, reduce, etc.) the mixing of species (e.g., fluids) while exchanging pressure (e.g., from one fluid to another fluid). The hydraulic energy transfer system may include an IPX configured to exchange pressure between a first fluid and a second fluid. The IPX may form a duct (e.g., channel) from a first duct opening formed by the IPX to a second duct opening formed by the IPX. The IPX is configured to direct the first fluid to a first duct opening having a first width (e.g., first opening width) and the second fluid to a second duct opening having a second width (e.g., second opening width). The IPX may include a floating piston disposed within the duct that reduces (e.g., prevents) mixing of the first and second fluid while allowing pressure exchange (e.g., while exchanging pressure) between the first fluid and the second fluid. The IPX may include a first adapter plate and a second adapter plate. The first adapter plate may prevent the floating piston from exiting the duct via the first duct opening. The second adapter plate may prevent the floating piston from exiting the duct via the second duct opening.

In some embodiments, a hydraulic energy transfer system (e.g., rotary IPX) may include an IPX configured to exchange pressure between a first fluid and a second fluid. The IPX may form a duct (e.g., channel) from a first duct opening formed by the IPX to a second duct opening formed by the IPX. The IPX may be configured to direct the first fluid to a first duct opening and the second fluid to the second duct opening. The IPX may include a first piston disposed within the duct. The first piston forms a first fluid seal within the duct. The IPX may further include a second piston disposed within the duct. The second piston may form a second fluid seal within the duct. The IPX may further include a rod disposed between the first piston and the second piston within the duct. The rod may be configured to reciprocate axial motion between the first piston and the second piston to transfer pressure between the first fluid and the second fluid.

In some embodiments, a rotary IPX (e.g., configured to exchange pressure between a first fluid and a second fluid) includes a rotor configured to rotate about a central axis. The rotor may form a duct (e.g., channel) from a first duct opening formed by the rotor to a second duct opening formed by the rotor. The rotary IPX may direct the first fluid to a first duct opening and the second fluid to a second duct opening. The IPX may further include a first piston disposed within the duct. The first piston may form a fluid seal within the duct to limit the mixing of the first fluid and the second fluid and transfer pressure between the first fluid and the second fluid. The first piston may include an axially symmetric structure configured to slide within the duct axially.

The devices and systems disclosed herein have advantages over conventional solutions. The hydraulic energy transfer system of the present disclosure may include a corresponding moving barrier disposed within each of one or more duct formed by a pressure exchanger. Each moving barrier of the present disclosure can reduce the mixing amount while maintaining pressure exchange between multiple fluids. The hydraulic energy transfer system of the present disclosure may exchange pressure between fluids that have unbalanced flow (e.g., some lead or lag flow), whereas conventional systems often require balanced flow (e.g., no lead or lag flow) to be able to operate. The present disclosure provides cross-contamination mitigation that can enable a greater diversity of viable fluids to be used in a pressure exchanger while maintaining greater pressure exchange efficiency (e.g., amount of fluid to be output by the pressure exchanger) that conventional systems. Although some embodiments of the present disclosure are described in relation to isobaric pressure exchangers, pressure exchangers, and hydraulic energy transfer systems, the current disclosure can be applied to other systems and devices (e.g., pressure exchanger that is not isobaric, rotating components that are not a pressure exchanger, a pressure exchanger that is not rotary, etc.).

Although some embodiments of the present disclosure are described in relation to exchanging pressure between fluid used in fracing systems, desalinization systems, and/or refrigeration systems, the present disclosure can be applied to other types of systems. Fluids can refer to liquid, gas, transcritical fluid, supercritical fluid, subcritical fluid, and/or combinations thereof.

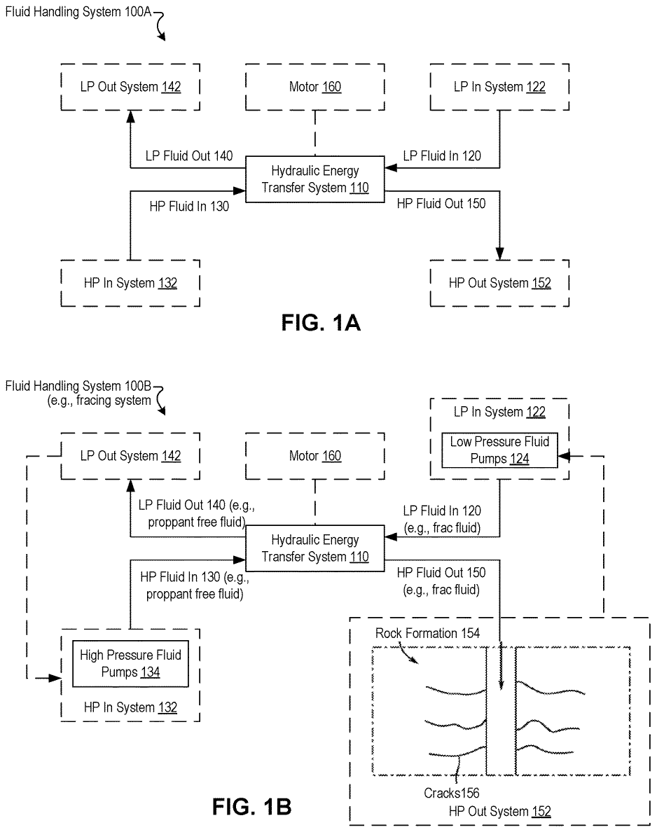

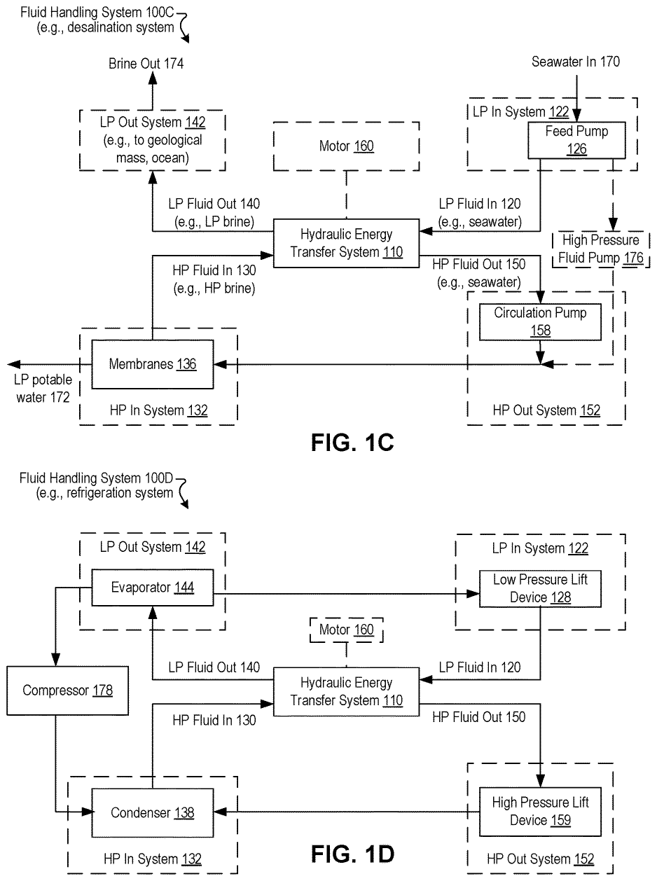

FIGS. 1A-D illustrate schematic diagrams of fluid handling systems 100 including hydraulic energy transfer systems, according to certain embodiments. Fluid handling systems 100 may include hydraulic energy transfer systems 110 that include a reduced mixing pressure exchanger (e.g., includes pistons in the ducts formed by the rotor) of the present disclosure.

FIG. 1A illustrates a schematic diagram of a fluid handling system 100A including a hydraulic energy transfer system 110 (e.g., rotary IPX), according to certain embodiments.

The hydraulic energy transfer system 110 (e.g., IPX) receives low pressure (LP) fluid in 120 (e.g., low-pressure inlet stream) from a LP in system 122. The hydraulic energy transfer system 110 also receives high pressure (HP) fluid in 130 (e.g., high-pressure inlet stream) from HP in system 132. The hydraulic energy transfer system 110 (e.g., IPX) exchanges pressure between the HP fluid in 130 and the LP fluid in 120 to provide LP fluid out 140 (e.g., low-pressure outlet stream) to LP fluid out system 142 and to provide HP fluid out 150 (e.g., high-pressure outlet stream) to HP fluid out system 152.

In some embodiments, the hydraulic energy transfer system 110 includes an IPX to exchange pressure between the HP fluid in 130 and the LP fluid in 120. The IPX may be a device that transfers fluid pressure between HP fluid in 130 and LP fluid in 120 at efficiencies in excess of approximately 50%, 60%, 70%, 80%, 90%, or greater (e.g., without utilizing centrifugal technology). Centrifugal technology may include a device spinning a fluid at a high speed to separate fluids of different densities. The fluids are forced outward from a radial direction about a central rotating axis. The notation of “first” fluid and “second” fluid is merely exemplary and not used to identify or limit each fluid to any specified limitation herein.

High pressure (e.g., HP fluid in 130, HP fluid out 150) refers to pressures greater than the low pressure (e.g., LP fluid in 120, LP fluid out 140). LP fluid in 120 of the IPX may be pressurized and exit the IPX at high pressure (e.g., HP fluid out 150, at a pressure greater than that of LP fluid in 120), and HP fluid in 130 may be depressurized and exit the IPX at low pressure (e.g., LP fluid out 140, at a pressure less than that of the HP fluid in 130). The IPX may operate with the HP fluid in 130 directly applying a force to pressurize the LP fluid in 120, with or without a fluid separator between the fluids. Examples of fluid separators that may be used with the IPX include, but are not limited to, pistons, bladders, diaphragms and the like. In some embodiments, IPXs may be rotary devices. Rotary IPXs, such as those manufactured by Energy Recovery, Inc. of San Leandro, Calif., may not have any separate valves, since the effective valving action is accomplished internal to the device via the relative motion of a rotor with respect to end covers. Rotary IPXs may be designed to operate with internal pistons to isolate fluids and transfer pressure with relatively little mixing of the inlet fluid streams. Reciprocating IPXs may include a piston moving back and forth in a cylinder for transferring pressure between the fluid streams. Any IPX or multiple IPXs may be used in the present disclosure, such as, but not limited to, rotary IPXs, reciprocating IPXs, or any combination thereof. In addition, the IPX may be disposed on a skid separate from the other components of a fluid handling system 100 (e.g., in situations in which the IPX is added to an existing fluid handling system).

In some embodiments, a motor 160 is coupled to hydraulic energy transfer system 110 (e.g., to an IPX). In some embodiments, the motor 160 controls the speed of a rotor of the hydraulic energy transfer system 110 (e.g., to increase pressure of HP fluid out 150, to decrease pressure of HP fluid out 150, etc.). In some embodiments, motor 160 generates energy (e.g., acts as a generator) based on pressure exchanging in hydraulic energy transfer system 110.

The hydraulic energy transfer system 110 may be a hydraulic protection system (e.g., hydraulic buffer system, hydraulic isolation system) that may block or limit contact between solid particle laden fluid (e.g., frac fluid) and various equipment (e.g., hydraulic fracturing equipment, high-pressure pumps) while exchanging work and/or pressure with another fluid. By blocking or limiting contact between various equipment (e.g., fracturing equipment) and solid particle containing fluid, the hydraulic energy transfer system 110 increases the life and performance, while reducing abrasion and wear, of various equipment (e.g., fracturing equipment, high pressure fluid pumps). Less expensive equipment may be used in the fluid handling system 100 by using equipment (e.g., high pressure fluid pumps) not designed for abrasive fluids (e.g., frac fluids and/or corrosive fluids).

The hydraulic energy transfer system 110 may include a hydraulic turbocharger or hydraulic pressure exchange system, such as a rotating IPX. The IPX may include one or more chambers (e.g., 1 to 100) to facilitate pressure transfer and equalization of pressures between volumes of first and second fluids (e.g., gas, liquid, multi-phase fluid).

The hydraulic energy transfer system 110 may be used in different types of systems, such as fracing systems, desalination systems, refrigeration systems, etc.

FIG. 1B illustrates a schematic diagram of a fluid handling system 100B including a hydraulic energy transfer system 110, according to certain embodiments. Fluid handling system 100B may be a fracing system. In some embodiments, fluid handling system 100B includes more components, less components, same routing, different routing, and/or the like than that shown in FIG. 1B.

LP fluid in 120 and HP fluid out 150 may be frac fluid (e.g., fluid including solid particles, proppant fluid, etc.). HP fluid in 130 and LP fluid out 140 may be substantially solid particle free fluid (e.g., proppant free fluid, water, filtered fluid, etc.).

LP in system 122 may include one or more low pressure fluid pumps to provide LP fluid in 120 to the hydraulic energy transfer system 110 (e.g., IPX). HP in system 132 may include one or more high pressure fluid pumps 134 to provide HP fluid in 130 to hydraulic energy transfer system 110.

Hydraulic energy transfer system 110 exchanges pressure between LP fluid in 120 (e.g., low pressure frac fluid) and HP fluid in 130 (e.g., high pressure water) to provide HP fluid out 150 (e.g., high pressure frac fluid) to HP out system 152 and to provide LP fluid out 140 (e.g., low pressure water). HP out system 152 may include a rock formation 154 (e.g., well) that includes cracks 156. The solid particles (e.g., proppants) from HP fluid out 150 may be provided into the cracks 156 of the rock formation.

In some embodiments, LP fluid out 140, high pressure fluid pumps 134, and HP fluid in 130 are part of a first loop (e.g., proppant free fluid loop). The LP fluid out 140 may be provided to the high pressure fluid pumps to generate HP fluid in 130 that becomes LP fluid out 140 upon exiting the hydraulic energy transfer system 110.

In some embodiments, LP fluid in 120, HP fluid out 150, and low pressure fluid pumps 124 are part of a second loop (e.g., proppant containing fluid loop). The HP fluid out 150 may be provided into the rock formation 154 and then pumped from the rock formation 154 by the low pressure fluid pumps 124 to generate LP fluid in 120.

In some embodiments, fluid handling system 100B is used in well completion operations in the oil and gas industry to perform hydraulic fracturing (e.g., fracking, fracing) to increase the release of oil and gas in rock formations 154. HP out system 152 may include rock formations 154 (e.g., a well). Hydraulic fracturing may include pumping HP fluid out 150 containing a combination of water, chemicals, and solid particles (e.g., sand, ceramics, proppant) into a well (e.g., rock formation 154) at high pressures. LP fluid in 120 and HP fluid out 150 may include a particulate laden fluid that increases the release of oil and gas in rock formations 154 by propagating and increasing the size of cracks 156 in the rock formations 154. The high pressures of HP fluid out 150 initiates and increases size of cracks 156 and propagation through the rock formation 154 to release more oil and gas, while the solid particles (e.g., powders, debris, etc.) enter the cracks 156 to keep the cracks 156 open (e.g., prevent the cracks 156 from closing once HP fluid out 150 is depressurized).

In order to pump this particulate laden fluid into the rock formation 154 (e.g., a well), the fluid handling system 100B may include one or more high pressure fluid pumps 134 and one or more low pressure fluid pumps 124 coupled to the hydraulic energy transfer system 110. For example, the hydraulic energy transfer system 110 may be a hydraulic turbocharger or an IPX (e.g., a rotary IPX). In operation, the hydraulic energy transfer system 110 transfers pressures without any substantial mixing between a first fluid (e.g., HP fluid in 130, proppant free fluid) pumped by the high pressure fluid pumps 134 and a second fluid (e.g., LP fluid in 120, proppant containing fluid, frac fluid) pumped by the low pressure fluid pumps 124. In this manner, the hydraulic energy transfer system 110 blocks or limits wear on the high pressure fluid pumps 134, while enabling the fluid handling system 100B to pump a high-pressure frac fluid (e.g., HP fluid out 150) into the rock formation 154 to release oil and gas. In order to operate in corrosive and abrasive environments, the hydraulic energy transfer system 110 may be made from materials resistant to corrosive and abrasive substances in either the first and second fluids. For example, the hydraulic energy transfer system 110 may be made out of ceramics (e.g., alumina, cermets, such as carbide, oxide, nitride, or boride hard phases) within a metal matrix (e.g., Co, Cr or Ni or any combination thereof) such as tungsten carbide in a matrix of CoCr, Ni, NiCr or Co.

In some embodiments, the hydraulic energy transfer system 110 includes an IPX (e.g., rotary IPX) and HP fluid in 130 (e.g., the first fluid, high-pressure solid particle free fluid) enters a first side of the IPX where the HP fluid in 130 contacts LP fluid in 120 (e.g., the second fluid, low-pressure frac fluid) entering the IPX on a second side. The contact between the fluids enables the HP fluid in 130 to increase the pressure of the second fluid (e.g., LP fluid in 120), which drives the second fluid out (e.g., HP fluid out 150) of the IPX and down a well (e.g., rock formation 154) for fracturing operations. The first fluid (e.g., LP fluid out 140) similarly exits the IPX, but at a low pressure after exchanging pressure with the second fluid. As noted above, the second fluid may be a low-pressure frac fluid that may include abrasive particles, which may wear the interface between the rotor and the respective end covers as the rotor rotates relative to the respective end covers.

The IPX of hydraulic energy transfer system 110 in fluid handling system 100B includes one or more inserts between rotor ports of the rotor and/or between end cover ports of the end cover. In some embodiments, the inserts may resist erosion and/or abrasion. In some embodiments, the inserts may be replaceable. The inserts may prevent abrasion and/or erosion from fluids with solid particles (e.g., frac fluid, proppant fluid), corrosive fluids, high pressure fluids, and/or the like.

FIG. 1C illustrates a schematic diagram of a fluid handling system 100C including a hydraulic energy transfer system 110, according to certain embodiments. Fluid handling system 100C may be a desalination system (e.g., remove salt and/or other minerals from water). In some embodiments, fluid handling system 100C includes more components, less components, same routing, different routing, and/or the like than that shown in FIG. 1C.

LP in system 122 may include a feed pump 126 (e.g., low pressure fluid pump 124) that receives seawater in 170 (e.g., feed water from a reservoir or directly from the ocean) and provides LP fluid in 120 (e.g., low pressure seawater, feed water) to hydraulic energy transfer system 110 (e.g., IPX). HP in system 132 may include membranes 136 that provide HP fluid in 130 (e.g., high pressure brine) to hydraulic energy transfer system 110 (e.g., IPX). The hydraulic energy transfer system 110 exchanges pressure between the HP fluid in 130 and LP fluid in 120 to provide HP fluid out 150 (e.g., high pressure seawater) to HP out system 152 and to provide LP fluid out 140 (e.g., low pressure brine) to LP out system 142 (e.g., geological mass, ocean, sea, discarded, etc.).

The membranes 136 may be a membrane separation device configured to separate fluids traversing a membrane, such as a reverse osmosis membrane. Membranes 136 may provide HP fluid in 130 which is a concentrated feed-water or concentrate (e.g., brine) to the hydraulic energy transfer system 110. Pressure of the HP fluid in 130 may be used to compress low-pressure feed water (e.g., LP fluid in 120) to be high pressure feed water (e.g., HP fluid out 150). For simplicity and illustration purposes, the term feed water is used. However, fluids other than water may be used in the hydraulic energy transfer system 110.

The circulation pump 158 (e.g., turbine) provides the HP fluid out 150 (e.g., high pressure seawater) to membranes 136. The membranes 136 filter the HP fluid out 150 to provide LP potable water 172 and HP fluid in 130 (e.g., high pressure brine). The LP out system 142 provides brine out 174 (e.g., to geological mass, ocean, sea, discarded, etc.).

In some embodiments, a high pressure fluid pump 176 is disposed between the feed pump 126 and the membranes 136. The high pressure fluid pump 176 increases pressure of the low pressure seawater (e.g., LP fluid in 120, provides high pressure feed water) to be mixed with the high pressure seawater provided by circulation pump 158.

In some embodiments, use of the hydraulic energy transfer system 110 decreases the load on high pressure fluid pump 176. In some embodiments, fluid handling system 100C provides LP potable water 172 without use of high pressure fluid pump 176. In some embodiments, fluid handling system 100C provides LP potable water 172 with intermittent use of high pressure fluid pump 176.

In some examples, hydraulic energy transfer system 110 (e.g., IPX) receives LP fluid in 120 (e.g., low-pressure feed-water) at about 30 pounds per square inch (PSI) and receives HP fluid in 130 (e.g., high-pressure brine or concentrate) at about 980 PSI. The hydraulic energy transfer system 110 (e.g., IPX) transfers pressure from the high-pressure concentrate (e.g., HP fluid in 130) to the low-pressure feed-water (e.g., LP fluid in 120). The hydraulic energy transfer system 110 (e.g., IPX) outputs HP fluid out 150 (e.g., high pressure (compressed) feed-water) at about 965 PSI and LP fluid out 140 (e.g., low-pressure concentrate) at about 15 PSI. Thus, the hydraulic energy transfer system 110 (e.g., IPX) may be about 97% efficient since the input volume is about equal to the output volume of the hydraulic energy transfer system 110 (e.g., IPX), and 965 PSI is about 97% of 980 PSI.

The IPX of hydraulic energy transfer system 110 in fluid handling system 100C includes one or more inserts between rotor ports of the rotor and/or between end cover ports of the end cover. In some embodiments, the inserts may resist erosion and/or abrasion. In some embodiments, the inserts may be replaceable. The inserts may prevent abrasion and/or erosion from fluids with solid particles (e.g., brine, seawater, etc.), corrosive fluids, high pressure fluids, and/or the like.

FIG. 1D illustrates a schematic diagram of a fluid handling system 100D including a hydraulic energy transfer system 110, according to certain embodiments. Fluid handling system 100D may be a refrigeration system (e.g., trans-critical carbon dioxide refrigeration system). The refrigeration system may use a fluid in a supercritical state. For example, the first and/or second fluid may include a refrigerant (e.g., carbon dioxide). In some embodiments, fluid handling system 100D includes more components, less components, same routing, different routing, and/or the like than that shown in FIG. 1D.

Hydraulic energy transfer system 110 (e.g., IPX) may receive LP fluid in 120 from LP in system 122 (e.g., low pressure lift device 128, low pressure fluid pump, etc.) and HP fluid in 130 from HP in system 132 (e.g., condenser 138). The hydraulic energy transfer system 110 (e.g., IPX) may exchange pressure between the LP fluid in 120 and HP fluid in 130 to provide HP fluid out 150 to HP out system 152 (e.g., high pressure lift device 159) and to provide LP fluid out 140 to LP out system 142 (e.g., evaporator 144). The evaporator 144 may provide the fluid to compressor 178 and low pressure lift device 128. The condenser 138 may receive fluid from compressor 178 and high pressure lift device 159.

The fluid handling system 100D may be a closed system. LP fluid in 120, HP fluid in 130, LP fluid out 140, and HP fluid out 150 may all be a fluid (e.g., refrigerant) that is circulated in the closed system of fluid handling system 100D.

In some embodiments, the fluids of one or more of FIGS. 1A-E may be multi-phase fluids such as gas/liquid flows, gas/solid particulate flow, liquid/solid particulate flows, gas/liquid/solid particulate flows, or any other multi-phase flow. For example, the multi-phase fluids may also be non-Newtonian fluids (e.g., shear-thinning fluid), highly viscous fluids, non-Newtonian fluids containing proppant, or highly viscous fluids containing proppant. Further, the first fluid may be at a pressure between approximately 5,000 kPa to 25,000 kPa, 20,000 kPa to 50,000 kPa, 40,000 kPa to 75,000 kPa, 75,000 kPa to 100,000 kPa, and/or greater than a second pressure of the second fluid. The hydraulic energy transfer system 110 may or may not completely equalize pressure between the first and second fluids. Accordingly, the hydraulic energy transfer system 110 may operate isobarically or substantially isobarically.

The hydraulic energy transfer system 110 may also be described as a hydraulic protection system, a hydraulic buffer system, or a hydraulic isolation system, because the hydraulic energy transfer system 110 may block or limit contact between a fluid (e.g., a frac fluid) and various equipment (e.g., hydraulic fracturing equipment, high-pressure pumps, high pressure fluid pumps 134), while still exchanging work and/or pressure between the first and second fluids. Moreover, the hydraulic energy transfer system 110 may enable the fluid handling system to use high-pressure pumps that are not configured for abrasive fluids (e.g., frac fluids and/or corrosive fluids). To facilitate rotation, the hydraulic energy transfer system 102 may couple to a motor 160 (e.g., out-board motor system) or may include a motor 160 within a casing of the hydraulic energy transfer system (e.g., an in-board motor system, electric motor is configured to drive rotation of the rotor). For example, the motor 160 may include an electric motor, a hydraulic motor, a pneumatic motor, another rotary drive, or any combination thereof. In operation, the motor 160 enables the hydraulic energy transfer system 110 to rotate with highly viscous and/or fluids that have solid particles, powders, debris, etc. For example, the motor 160 may facilitate startup with highly viscous or particulate-laden fluids, which enables a rapid start of the hydraulic energy transfer system 110. The motor 160 may also provide an additional force that enables the hydraulic energy transfer system 110 to grind through particulate to maintain a proper operating speed (e.g., rpm) with a highly viscous/particulate-laden fluid. Additionally, the motor 160 may also substantially extend the operating range of the hydraulic energy transfer system 110. For example, the motor 160 may enable the hydraulic energy transfer system 110 to operate with good performance at lower or higher flow rates than a “free-wheeling” hydraulic energy transfer system without a motor, because the motor 160 may facilitate control of the speed (e.g., rotating speed) of the hydraulic energy transfer system 110 and control of the degree of mixing between the first and second fluids.

The hydraulic energy transfer system 110 may include a low-pressure port configured to receive a first fluid under a first pressure. The hydraulic energy transfer system 110 may further include a rotor fluidly coupled to (e.g., in a flow path of the low-pressure port). The hydraulic energy transfer system 110 may further include a shaft routed through a centerbore formed by the hydraulic energy transfer system 110. The shaft may be attached to the rotor.

In some embodiments, as will be discussed in associated with other Figures, third fluid may be used to pump fluid to the hydraulic energy transfer system 110. In some embodiments, the hydraulic energy transfer system 110 may be driven by a third fluid (e.g., a portion of the first fluid and/or second fluid) that is routed to the rotor of the hydraulic energy transfer system 110 to facilitate rotation. For example, absent the motor 160, it may be difficult to drive the hydraulic energy transfer system 110 (e.g., to initialize rotation of the rotor). The presence of moving barriers in the ducts may prevent flow from passing through the PX when the PX (e.g., the rotor) is not spinning. Without pass through flow, hydraulic torque may not (e.g., cannot) be imparted to the rotor to overcome frictional forces and cause the rotor to spin. In such a scenario, a motor, hydraulic drive, etc. may be used to start the rotor.

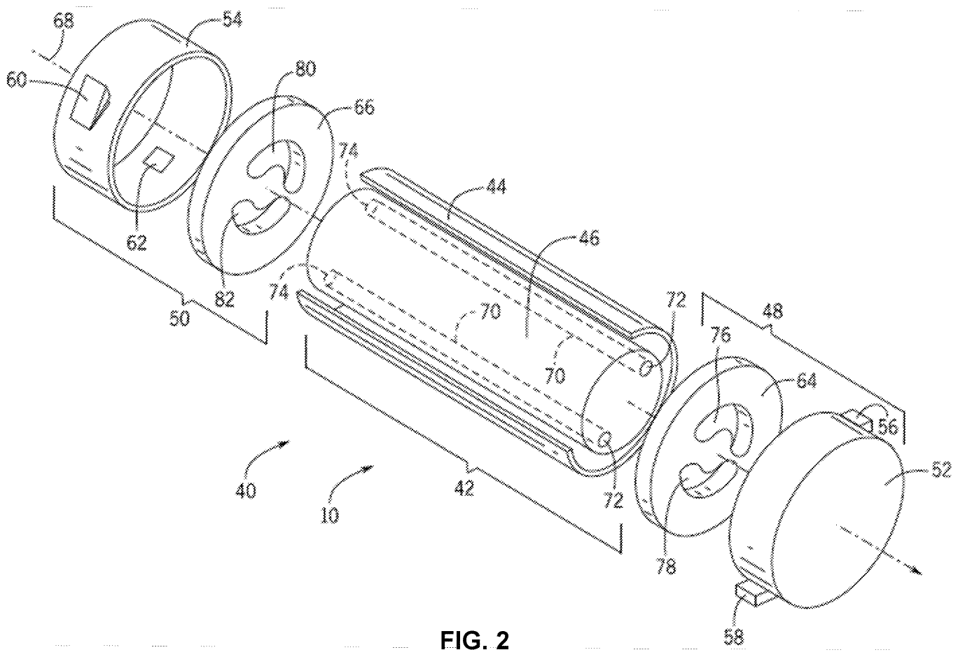

FIGS. 2-6 are exploded perspective views of a rotary PX 40 (e.g., rotary pressure exchanger, rotary liquid piston compressors (LPCs), etc.), according to certain embodiments. Rotary PX 40 may be a reduced mixing pressure exchanger (e.g., includes pistons in the ducts formed by the rotor) of the present disclosure.

The rotary PX 40 is configured to transfer pressure and/or work between a first fluid (e.g., proppant free fluid or supercritical carbon dioxide, HP fluid in 130) and a second fluid (e.g., frac fluid or superheated gaseous carbon dioxide, LP fluid in 120) with minimal mixing of the fluids, according to certain embodiments. The rotary PX 40 may include a generally cylindrical body portion 42 that includes a sleeve 44 (e.g., rotor sleeve) and a rotor 46. The rotary PX 40 may also include two end caps 48 and 50 that include manifolds 52 and 54, respectively. Manifold 52 includes respective inlet port 56 and outlet port 58, while manifold 54 includes respective inlet port 60 and outlet port 62. In operation, these inlet ports 56, 60 enable the first and second fluids to enter the rotary PX 40 to exchange pressure, while the outlet ports 58, 62 enable the first and second fluids to then exit the rotary PX 40. In operation, the inlet port 56 may receive a high-pressure first fluid (e.g., HP fluid in 130), and after exchanging pressure, the outlet port 58 may be used to route a low-pressure first fluid (e.g., LP fluid out 140) out of the rotary PX 40. Similarly, the inlet port 60 may receive a low-pressure second fluid (e.g., LP fluid in 120) and the outlet port 62 may be used to route a high-pressure second fluid (e.g., HP fluid out 150) out of the rotary PX 40. The end caps 48 and 50 include respective end covers 64 and 66 (e.g., end plates) disposed within respective manifolds 52 and 54 that enable fluid sealing contact with the rotor 46.

The rotor 46 may be cylindrical and disposed in the sleeve 44, which enables the rotor 46 to rotate about the axis 68. The rotor 46 may form a plurality of channels 70 (e.g., ducts, rotor ducts) extending substantially longitudinally through the rotor 46 between openings 72 and 74 (e.g., rotor ports, rotor openings) at each end arranged symmetrically about the longitudinal axis 68. The openings 72 and 74 of the rotor 46 are arranged for hydraulic communication with inlet and outlet apertures 76 and 78 (e.g., end cover inlet port and end cover outlet port) and 80 and 82 in the end covers 64 and 66, in such a manner that during rotation the channels 70 are exposed to fluid at high-pressure and fluid at low-pressure. As illustrated, the inlet and outlet apertures 76 and 78; and 80 and 82 may be configured in the form of arcs or segments of a circle (e.g., C-shaped).

In some embodiments, a controller using sensor feedback (e.g., revolutions per minute measured through a tachometer or optical encoder or volume flow rate measured through flowmeter) may control the extent of mixing between the first and second fluids in the rotary PX 40, which may be used to improve the operability of the pressure exchange system (e.g., fluid handling systems 100A-D of FIGS. 1A-D). For example, varying the volume flow rates of the first and second fluids entering the rotary PX 40 allows the plant operator (e.g., system operator) to control the amount of fluid mixing within the PX 40 (e.g., rotary liquid piston compressor 10). In addition, varying the rotational speed of the rotor 46 also allows the operator to control mixing. Mixing in a rotary PX 40 is affected by one or more of fluid turbulence in the duct, extent of fluid travel within the duct, diffusion due to concentration gradients, jetting caused during pressure equalization, pressure spikes due to fluid inertia, etc. The rotor channels 70 are generally long and narrow, which stabilizes the flow within the rotary PX 40. The first and second fluids may move through the channels 70 in a plug flow regime with minimal axial mixing. In certain embodiments, the speed of the rotor 46 reduces contact between the first and second fluids. For example, the speed of the rotor 46 (e.g., rotor speed of approximately 1200 RPM) may reduce contact times between the first and second fluids to less than approximately 0.15 seconds, 0.10 seconds, or 0.05 seconds. Third, a small portion of the rotor channel 70 is used for the exchange of pressure between the first and second fluids. Therefore, a volume of fluid remains in the channel 70 as a barrier between the first and second fluids. All these mechanisms may limit mixing within the rotary PX 40. Moreover, in some embodiments, the rotary PX 40 may be configured to operate with internal pistons or other barriers, either complete or partial, that isolate the first and second fluids while enabling pressure transfer.

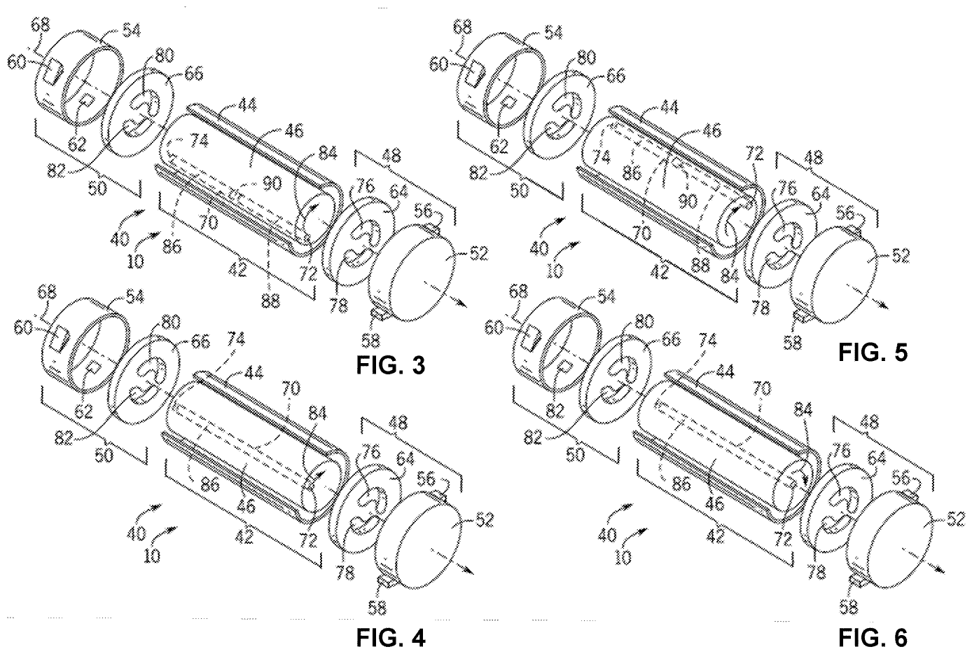

FIGS. 3-6 are exploded views of an embodiment of the rotary PX 40 illustrating the sequence of positions of a single rotor channel 70 in the rotor 46 as the channel 70 rotates through a complete cycle. It is noted that FIGS. 3-6 are simplifications of the rotary PX 40 showing one rotor channel 70, and the channel 70 is shown as having a circular cross-sectional shape. In other embodiments, the rotary PX 40 may include a plurality of channels 70 with the same or different cross-sectional shapes (e.g., circular, oval, square, rectangular, polygonal, etc.). Thus, FIG. 3-6 are simplifications for purposes of illustration, and other embodiments of the rotary PX 40 may have configurations different from that shown in FIGS. 2-6. As described in detail below, the rotary PX 40 facilitates pressure exchange between first and second fluids by enabling the first and second fluids to briefly contact each other within the rotor 46. In certain embodiments, this exchange happens at speeds that result in limited mixing of the first and second fluids. The speed of the pressure wave traveling through the rotor channel 70 (as soon as the channel is exposed to the aperture 76), the diffusion speeds of the fluids, and the rotational speed of rotor 46 dictate whether any mixing occurs and to what extent.

FIG. 3 is an exploded perspective view of an embodiment of a rotary PX 40 (e.g., rotary LPC), according to certain embodiments. In FIG. 3, the channel opening 72 is in a first position. In the first position, the channel opening 72 is in fluid communication with the aperture 78 in end cover 64 and therefore with the manifold 52, while the opposing channel opening 74 is in hydraulic communication with the aperture 82 in end cover 66 and by extension with the manifold 54. As will be discussed below, the rotor 46 may rotate in the clockwise direction indicated by arrow 84. In operation, low-pressure second fluid 86 passes through end cover 66 and enters the channel 70, where it contacts the first fluid 88 at a dynamic fluid interface 90. The second fluid 86 then drives the first fluid 88 out of the channel 70, through end cover 64, and out of the rotary PX 40. However, because of the short duration of contact, there is minimal mixing between the second fluid 86 and the first fluid 88.

FIG. 4 is an exploded perspective view of an embodiment of a rotary PX 40 (e.g., a rotary LPC), according to certain embodiments. In FIG. 4, the channel 70 has rotated clockwise through an arc of approximately 90 degrees. In this position, the opening 74 (e.g., outlet) is no longer in fluid communication with the apertures 80 and 82 of end cover 66, and the opening 72 is no longer in fluid communication with the apertures 76 and 78 of end cover 64. Accordingly, the low-pressure second fluid 86 is temporarily contained within the channel 70.

FIG. 5 is an exploded perspective view of an embodiment of a rotary PX 40 (e.g., a rotary LPC), according to certain embodiments. In FIG. 5, the channel 70 has rotated through approximately 60 degrees of arc from the position shown in FIG. 2. The opening 74 is now in fluid communication with aperture 80 in end cover 66, and the opening 72 of the channel 70 is now in fluid communication with aperture 76 of the end cover 64. In this position, high-pressure first fluid 88 enters and pressurizes the low-pressure second fluid 86, driving the second fluid 86 out of the rotor channel 70 and through the aperture 80.

FIG. 6 is an exploded perspective view of an embodiment of a rotary pressure exchanger or a rotary LPC, according to certain embodiments. In FIG. 6, the channel 70 has rotated through approximately 270 degrees of arc from the position shown in FIG. 2. In this position, the opening 74 is no longer in fluid communication with the apertures 80 and 82 of end cover 66, and the opening 72 is no longer in fluid communication with the apertures 76 and 78 of end cover 64. Accordingly, the first fluid 88 is no longer pressurized and is temporarily contained within the channel 70 until the rotor 46 rotates another 90 degrees, starting the cycle over again.

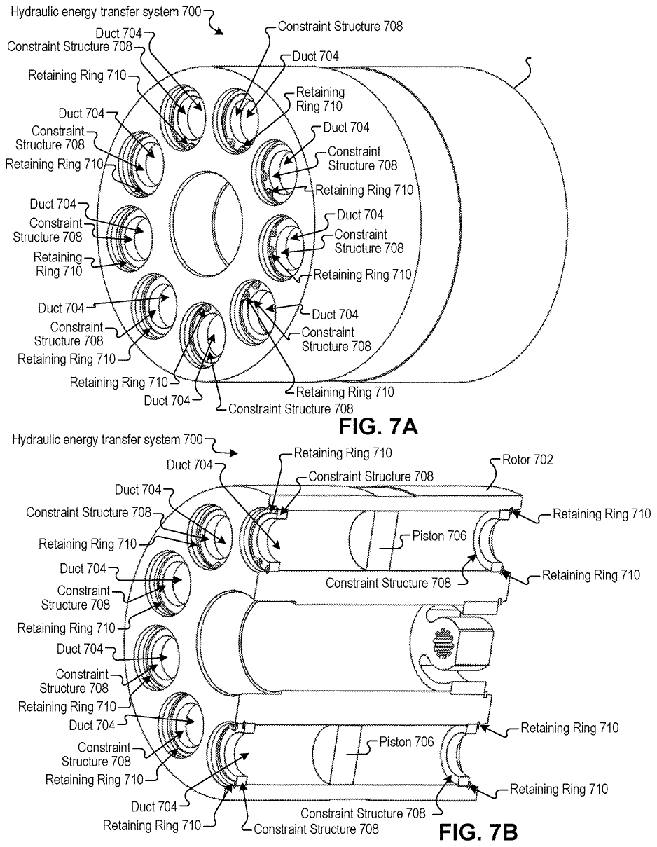

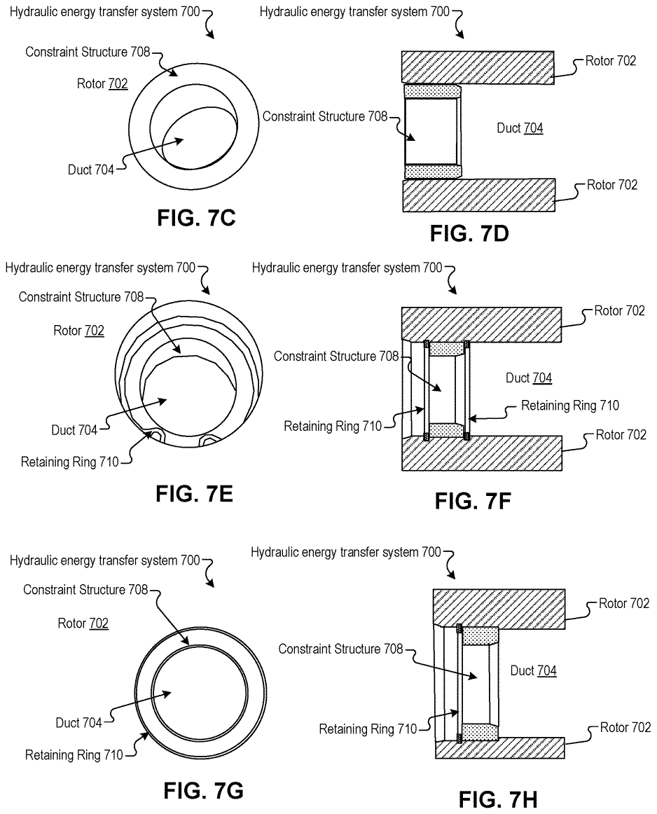

FIGS. 7A-H illustrate components associated with pressure exchangers, according to certain embodiments. FIG. 7A is a perspective view and FIG. 7B is a perspective cross-sectional view. As shown in FIGS. 7A-B, the hydraulic energy transfer system 700 (e.g., PX 40 of FIGS. 2-6) may include a rotor 702 having a cylindrical body. The rotor may be configured to rotate about a central axis (e.g., as explained in association with FIGS. 2-6). The rotor may form one or more ducts 704 (e.g., channels), where each of the ducts 704 is from a corresponding first opening (e.g., first duct opening on a first side of the rotor 702) formed by the rotor 702 to a corresponding second opening (e.g., second duct opening on a second side of the rotor 702) formed by the rotor 207. The first side (e.g., the first openings) may be configured to receive a first fluid and the second side (e.g., the second openings) may be configured to receive a second fluid. The ducts 704 are not limited to this exemplary cylindrical geometry. In some embodiments, the ducts form non-circular shapes such as triangular, rectangular, other polygon-shaped opening and corresponding three-dimensional structured channels. In some embodiments, the ducts are uniform ducts comprising the same width from end to end. In some embodiments, one or more ducts may include one or more portions having greater or lesser widths than other portions, as will be discussed in association with other embodiments.

As shown in FIG. 7B, a corresponding piston 706 may be disposed in one or more of the ducts 704. The pistons 706 may be floating pistons configured to slide within the duct. In some embodiments, the pistons 706 slide from the first opening to the second opening and, in other embodiments, the pistons 706 may slide within a portion of the duct 704 (e.g., in embodiments where the duct 702 has variously sized portions) The pistons 706 provide a barrier between the first fluid disposed on the first side of the PX and the second fluid disposed on the second side of the PX.

In operation, at a first stage of the pressure exchange process, a high-pressure first fluid enters the first side of the PX and applies a force against a surface of the piston 706. Responsive to receiving the force from the first fluid, the piston 706 slides axially through the duct 704, applying a force against a low-pressure second fluid disposed within the duct opposite the first fluid. The low-pressure second fluid receives the transmitted pressure from the first fluid through the piston 706 and is ejected at a pressure greater than the low-pressure with which the second fluid entered the second opening of the duct 704. At a second stage of the pressure exchange process, the second fluid enters the second opening of the duct 704 and applies a force against the piston 706. The piston 706 axially slides down the duct and ejects the fluid at a low pressure. The piston 706 is then in a position for the process to continue with the first stage. This process may be repeated over and over to continuously exchange pressure between the first fluid and the second fluid while minimizing fluid contact between the first fluid and the second fluid.

In some embodiments, the piston 706 forms a fluid seal within the duct 704. As will be discussed in later embodiments, the piston 706 may include contact seals such as a bidirectional seal. In some embodiments, the piston 706 may include two or more unidirectional seals. The seals may form one or more fluid seals within the ducts 704 to mitigate fluid mixing between the first fluid and the second fluid.

In some embodiments, the hydraulic energy transfer system 700 may include a pair of constraint structures 708 disposed within the ducts 704 or adjacent to the duct openings. The constraint structures 708 may be configured to contact the piston 706 and prevent the piston 706 from exiting the duct 704 at the first opening and/or the second opening. In some embodiments, the hydraulic energy transfer system 700 may include a first adapter plate disposed proximate the first opening. The first adapter plate may prevent the piston 706 from exiting the duct 704 at the first opening. The first adapter plate may form a first aperture that directs the first fluid to the first opening. The hydraulic energy transfer system 700 may include a second adapter plate disposed proximate the second opening. The second adapter plate may prevent the piston 706 from exiting the duct 704 at the second opening. The second adapter plate may form a second aperture that directs the second fluid to the second opening of the duct 704

The first aperture may have a first aperture width. The first opening width of the first duct opening may be larger than the first aperture width. The floating piston may include a first portion forming a fluid seal within the duct. The first portion may have a first portion width substantially equal to the first opening width. The floating piston may further include a second portion having a second portion width smaller than the first opening width. The second portion may be configured to fit within the first aperture.

In some embodiments, the rotor 702 may include a liner structure or coating disposed within one or more ducts 704. The liner structure or coating may include (e.g., may be comprised of) a material conducive for contact with floating pistons (e.g., forms a good wear couple). For example, a liner structure or coating may include material that generates less friction against the sliding piston than the surface of the duct alone. In some embodiments, the reduction of friction between the piston and an inner surface of the duct (e.g., a liner) may increase the fluid sealing capabilities of the piston. In some embodiments, the liner is held within the ducts 704 via external constraints (e.g., adapter plates) coupled to the rotor. In other embodiments, the liner may be coupled to the inner surface of the ducts 704 (e.g., using an adhesive or fastener or shrunk fit into the ducts).

Each constraint structure 708 may be press fit in the duct 704 formed by the rotor 702, shrunk fit in the duct 704 formed by the rotor 702, or restrained (e.g., between one or more retaining rings 710, between a retaining ring 710 and a duct sidewall of the rotor, etc.) in the duct 704 formed by the rotor 702. In some embodiments, liners are used in the ducts 704 and the constraint structure 708 on one end of the rotor 702 may be part of the liner.

In some embodiments, one or more retaining rings 710 (e.g., retaining structures) secure each constraint structure 708 in the duct 704 of the rotor 702. As shown in FIGS. 7A-B, a retaining ring 710 may be disposed proximate the distal end of the duct 704 and constraint structure 708 is disposed between the retaining ring 710 and a central portion of the duct 704.

FIGS. 7C-D illustrate hydraulic energy transfer systems 700, according to certain embodiments. FIG. 7C is a perspective view and FIG. 7D is a cross-sectional view. As shown in FIGS. 7C-D, constraint structure 708 may be secured in the duct via press fit. In some embodiments, the constraint structure 708 is a press-fit carbon fiber sleeve that constrains the piston from exiting the duct 704. In some embodiments, the constraint structure 708 engages a hydraulic nose (e.g., protruding portion, nose surface) of the piston. In some embodiments, the rotor 702 has a duct end chamfer for insertion of the constraint structure 708.

FIGS. 7E-F illustrate hydraulic energy transfer systems 700, according to certain embodiments. FIG. 7E is a perspective view and FIG. 7F is a cross-sectional view. As shown in FIGS. 7E-F, constraint structure 708 may be secured in the duct via two retaining rings 710. In some embodiments, constraint structure 708 is a slide-fit carbon fiber sleeve. The retaining rings 710 may be dual internal retaining rings in duct grooves formed by the rotor 702 to constrain sleeve axial motion of the constraint structure 708. The assembly of the retaining rings 710 and constraint structure 708 constrains the piston from exiting the duct 704. In some embodiments, the rotor 702 has a duct end chamfer for insertion of the constraint structure 708.

FIGS. 7G-H illustrate hydraulic energy transfer systems 700, according to certain embodiments. FIG. 7G is a perspective view and FIG. 7H is a cross-sectional view. As shown in FIGS. 7G-H, constraint structure 708 may be secured in the duct via a retaining ring 710. In some embodiments, constraint structure 708 is a slide-fit carbon fiber sleeve. The retaining ring 710 (e.g., single internal retaining ring) may be disposed in a duct groove formed by the rotor 702 to constrain sleeve outward motion of the constraint structure 708. The assembly of the retaining ring 710 and constraint structure 708 constrains the piston from exiting the duct 704. In some embodiments, the constraint structure 708 engages a hydraulic nose (e.g., protruding portion, nose surface) of the piston. In some embodiments, the rotor 702 has a duct end chamfer for insertion of the constraint structure 708. In some embodiments, the constraint structure 708 is retained between the retaining ring 701 and a duct sidewall of the rotor 702.

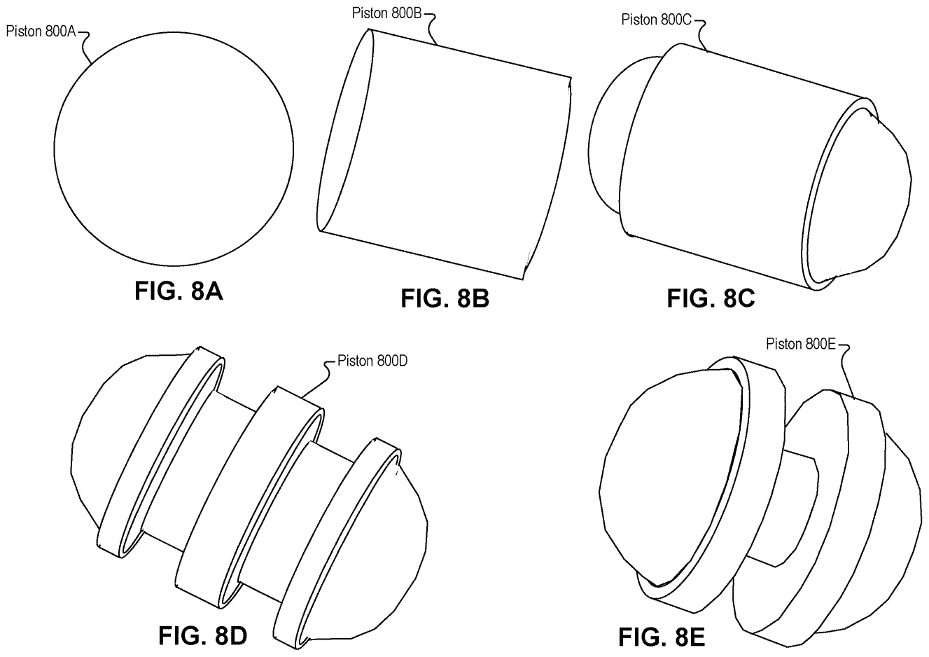

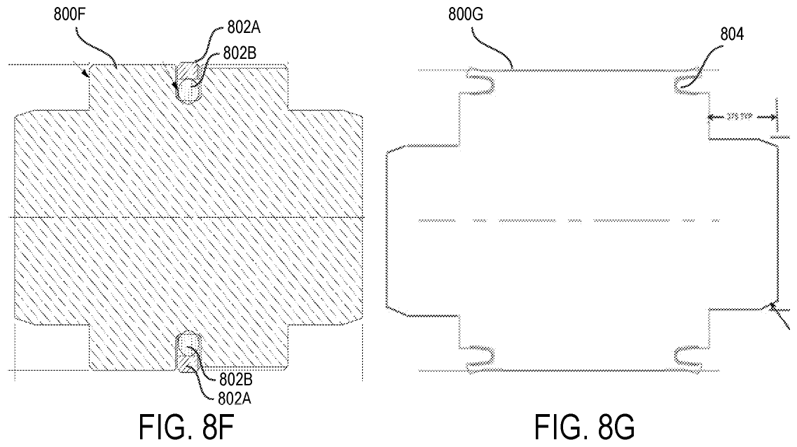

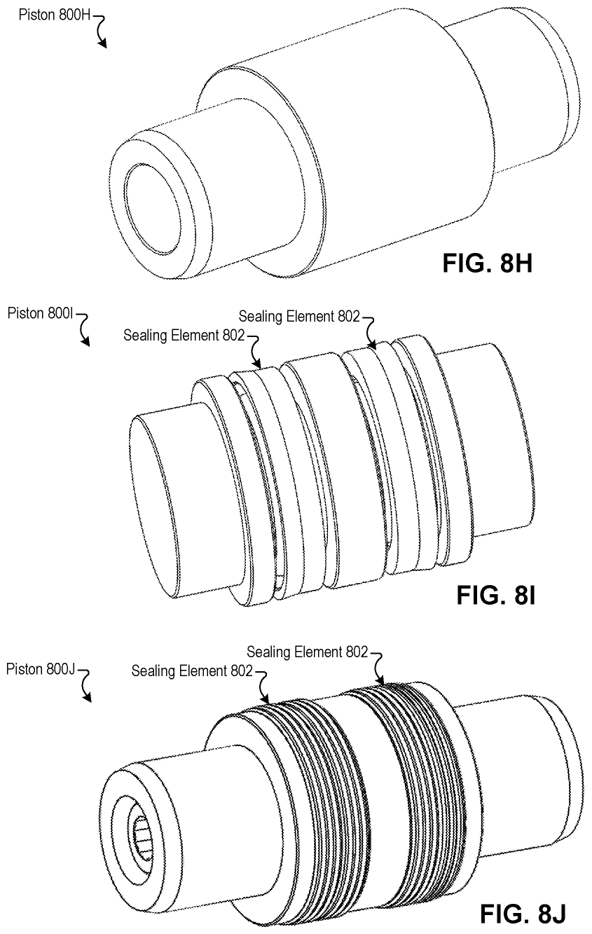

FIG. 8A-J illustrate various embodiments of floating pistons 800A-J (e.g., pistons), according to certain embodiments. The floating piston 800 may include a structure that is axially symmetric (e.g., axially symmetric about the axis of a duct 704). The piston may be spherical (e.g., piston 800A), cylindrical (e.g., piston 800B), or possess one or more shapes that fit within the width of the duct (e.g., triangular, rectangular, polygon-shaped, as described previously).

In some embodiments, the piston includes a curved contact surface (e.g., nose, nose surface, hydraulic nose, protrusion) to contact a constraint (e.g., an adapter plate, constraint structure) disposed at or near an opening of the duct (e.g., pistons 800A, 800C, 800D, and/or 800E, 800F, 800G, 800H, 800I, 800J). For example, the piston (e.g., 800C) may include a cylindrical body, a first curved contact surface (e.g., hydraulic nose, nose, nose surface, nose structure) disposed on a first end of the cylindrical body configured to engage with a first adapter plate (e.g., contact adapter plate, go within the opening formed by adapter plate), and a second curved contact surface disposed on a second end of the cylindrical body configured to engage with a second adapter plate.

In a further embodiment, the piston may include a cylindrical body having a first portion with a first width (e.g., first body width), a second portion with a second width (e.g., second body width), and a third portion disposed between the first portion and the second portion having a third width (e.g., third body width) less than the first width of the first portion and the second width of the second portion (e.g., pistons 800D, 800E, 800F, 800I, and/or 800J). The piston may include a portion with a larger width (e.g., first piston width) to contact a surface of the duct. For example, one or more larger-width cylindrical portions may be configured to form a fluid seal within the duct to prevent mixing of the first and second fluid while translating within the duct. Seals, linear bearings, and/or guides may be embedded within the grooves (e.g., see grooves of pistons 800D, 800E, 800F, 800I, and/or 800J) formed between the different portions of the piston to enhance sealing and alignment of the pistons during reciprocating motion.

In some embodiments, as described above, the piston may include a shape or structure that is axially symmetric. For example, the piston may be operational in both directions. In some embodiments, the one or more of pistons 800A-J may be able to travel from a first opening on a first end to a second opening on a second end. It should be noted that the ability of the piston to travel from end to end of the rotor can provide for a wider viability of rotor, duct, and piston dimensions not found in conventional systems. For example, a piston may include a first axial dimension, and the rotor duct may include a second axial dimension that is not limited to the length of the first dimensions. For example, the piston may be able to move completely from the first opening and the second opening within needing to be a minimum axial length relative to the second length dimension of the duct.

In some embodiments, one or more of pistons 800A-J may be comprised of flexible material capable of absorbing contact between the piston and an end constraint (e.g., adapter plate). In some embodiments, as will be discussed later, the piston may create a fluid seal between the piston, the adapter plate and an interior surface of the duct.

In some embodiments the piston may include a cylindrical body, a first curved contact surface disposed on a first end of the cylindrical body configured to engage with the first adapter plate, and a second curved contact surface disposed on a second end of the cylindrical body configured to engage with the second adapter plate. The cylindrical body may further include a first portion having a third width (e.g., body width), a second portion having the third width (e.g., body width), and a third portion disposed between the first portion and the second portion having a fourth width (e.g., body width) less than the third width.

FIGS. 8F-G illustrate cross-sectional areas of floating pistons 800F-G configured to be disposed in ducts of a pressure exchanger. As shown in FIG. 8F, a piston 800F may include one or more sealing elements 802 (e.g., a face seal, an O-ring, radial seal, etc.) that can form a fluid seal with an external surface (e.g., a surface of a duct of a rotor). For example, a sealing element 802A that meets a first threshold value (e.g., harder, less flexible, etc.) may be disposed on the outside to contact the duct surface and a sealing element 802B that meets a second threshold value (e.g., softer, more flexible, etc.) may be disposed between the sealing element 802A and the piston 800F. Sealing element 802A may resist wear while contacting the duct surface of the rotor. Sealing element 802B may push the sealing element 802A closer to the duct sidewall as the sealing element 802A becomes worn. It should be noted that although piston 800F is depicted with one sealing element 802A contacting the duct sidewall, multiple sealing elements may be used. For example, one or more unidirectional and/or bidirectional seals may be incorporated and/or coupled to the piston 800F. The seals may be energized using O-rings (as shown in FIG. 8F) or cantilevered springs (as shown in FIG. 8G) or other means to compensate for wear without loss of sealing function.

As shown in FIGS. 8F & 8G, a piston 800F-G may include a protrusion at either end configured to form a fluid pocket when the piston approaches an end of a duct and engages with the end constraint (e.g., constraint structure, adapter plate). As will be described further in other embodiments, the location and/or dimension of the protruded portion may affect a braking force applied to the piston when the piston approaches the end constraint. The piston may include protrusion on both axial sides of the piston to generate a braking force in an opposite direction when a piston approaches an end of the rotor.

FIG. 8H illustrates a piston 800H that has protrusions (e.g., nose, hydraulic nose, etc.) on either end and that does not form grooves. FIGS. 8I-J illustrates pistons 800I-J that have protrusions (e.g., nose, hydraulic nose, etc.) on either end and that form grooves to receive one or more sealing elements 802.

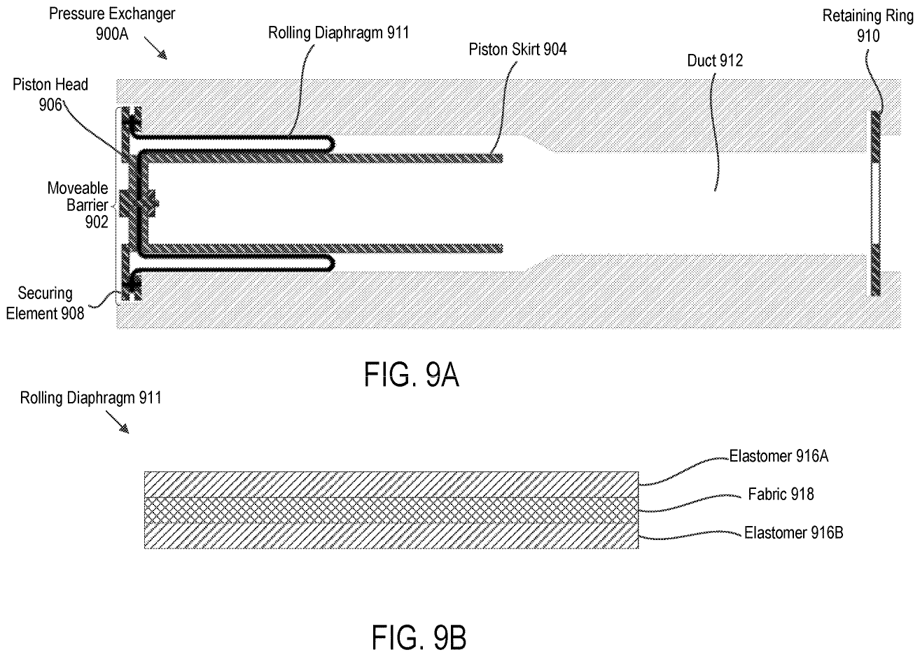

FIGS. 9A-B illustrate an embodiment of a pressure exchanger 900A with a moveable barrier, according to certain embodiments. A pressure exchanger 900A may form a duct 912 having an elongated channel with a first opening and a second opening. As shown in FIG. 9A, the duct 912 may include a first portion with a first width (e.g., first portion width) and a second portion with a second width (e.g., second portion width) that is smaller than the first width. The pressure exchanger 900A may include a moveable barrier 902 (e.g., elastic moveable barrier) that includes a piston skirt 904, a piston head 906, and a rolling diaphragm 911.

As shown in FIG. 9A, the rolling diaphragm 911 is disposed between (e.g., sandwiched between) the piston skirt 904 and the piston head 906. In some embodiments, the piston skirt 904 and the piston head may include (e.g., may be comprised of) a metal alloy such as aluminum. The rolling diaphragm 911 may also be coupled to the pressure exchanger 900A via a securing element 908 (e.g., fastener). As shown in FIG. 9B, the rolling diaphragm 911 may include a fabric 918 coated in an elastomer 916A and 916B. The elastomer may be configured to roll into a stretched position and retract into an upstretched position.

In operation, the first fluid applies a force on the moveable barrier 902, the piston skirt 904 slides along with the rolling diaphragm 911 and the piston head 906 axially within the duct 912. The piston skirt 904 contacts a second fluid disposed within the duct 912 and a side opposite the first fluid. For example, the second fluid may be disposed in a portion of the duct with a smaller width (e.g., smaller portion width).

As shown in FIG. 9A, the pressure exchanger 900A may include a retaining ring configured to the piston skirt 904. For example, the retaining ring may act as a barrier preventing the piston skirt 904 from translating outside the duct 912. The barrier ring 910 may include an aperture configured to direct a fluid into the duct 912.

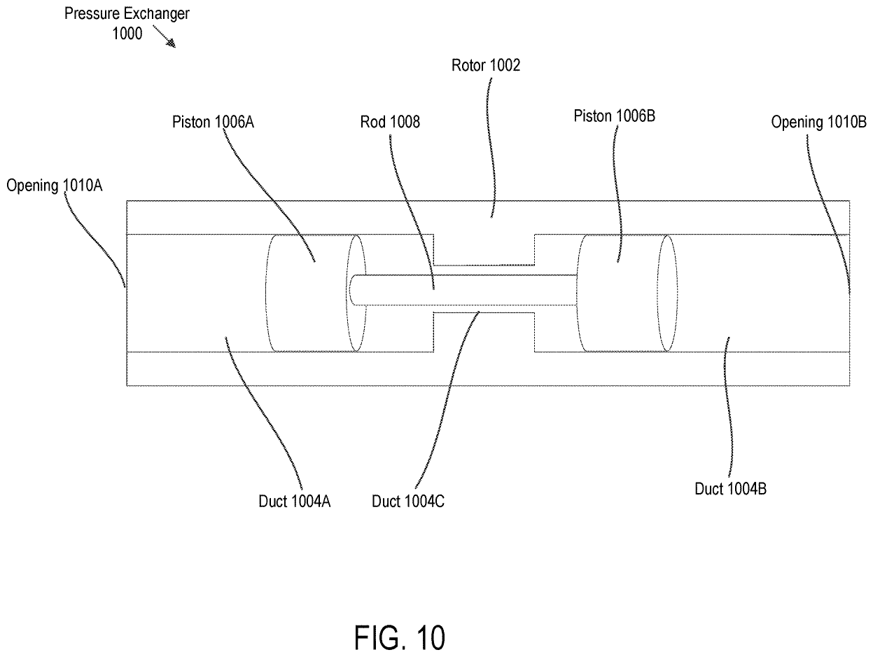

FIG. 10 illustrates a reciprocating dual-piston structure disposed within a duct of a PX 1000 (or LPC), according to certain embodiments. The PX 1000 may be configured to exchange pressure between a first fluid and a second fluid. The PX 1000 may include a duct 1000A-C formed in a rotor. The rotor and end cover assembly may be configured to direct the first fluid to an opening (e.g., 1010A) of the duct and the second fluid to a second opening (e.g., 1010B) of the duct. The PX 1000 may include a first piston (e.g., 1006A) disposed within the duct and a second piston (e.g., 1006B) disposed within the duct. The first piston may form a first fluid seal within the duct, and the second piston may form a second fluid seal within the duct. The PX 1000 may also include a rod disposed between the pistons 1000A-B within the duct. The rod may be configured to reciprocate axial motion between the pistons 1006A-B to transfer pressure between the first fluid and the second fluid.

In operation, a first fluid enters the duct at a first opening 1010A and applies a force on the first piston 1006. The rod 1008 reciprocates the force to the second piston 1006B and the dual piston assembly (e.g., a combination of piston 1006A, piston 1006B, and rod 1008) translates together within the duct. The movement of the second piston 1006B ejects the second fluid through the second opening 1010B.

In some embodiments, the duct may include a first portion 1004A proximate a first opening, the first portion may include a first width. The first piston 1006 may be disposed within the first portion 1004A. The duct may include a second portion 1004B proximate to a second opening. The second portion may include a second width. The second piston may be disposed within the second portion. In some embodiments, the width of the first portion 1004A and the width of the second portion 1004B is the same (or substantially the same). In some embodiments, the width of the third portion is smaller than the width of the first portion 1004A and the width of the second portion 1004B. In some embodiments, the duct may include more portions than three having various diameters.

In some embodiments, the pressure exchanger (PX) 1000 includes a fluid channel fluidly coupled to the third portion 1004C of the duct. The fluid channel may direct a third fluid to the third portion 1004C of the duct. The third fluid may be disposed between the first piston 1006A, the second piston 1006B, the rod 1008, and a surface formed by the duct. The PX 1000 may include a feed valve coupled to the fluid channel. The feed valve may control a third fluid flow in and out of the third portion of the duct and selectively seal the third fluid within the third portion 1004C of the duct. This third fluid acts as a barrier fluid preventing the mixing of the first fluid between the first piston 1006A and the first opening 1010A and the second fluid between the second piston 1006B and the second opening 1010B. The configuration of the dual piston assembly and a central constraint also allows for hydraulic braking of the piston to prevent harsh impact of the piston 1006A or piston 1006B with the duct. For example, as the dual piston assembly translates within the duct and approaches the third portion 1004C, a pocket of fluid gets trapped between the piston and third portion 1004C of the duct, provided the clearance between the rod 1008 and the third portion 1004C of the duct is “small.” This results in a rapid increase in pressure within the pocket and a resistive force is applied that slows the pistons. In some embodiments, the braking force may be applied bi-directionally. It should be noted that the third portion 1004C of the duct in FIG. 10 is depicted as being disposed at an axial center of the duct, however, in some embodiments, a portion of the duct with the smaller width may be disposed off-center.

In operation, in some embodiments, the PX 1000 may form a sealed pocket of fluid between the first piston 1006A, the second piston 1006B, and a surface of the duct. A braking force may be applied to at least one of the first piston 1006A when the first piston approaches the third portion 1004C or when the second piston 1006B approaches the third portion 1004C. In some embodiments, pressure in the sealed pocket of fluid is configured to increase in proportion to piston velocity of the floating piston to cause a braking force to be applied to the floating piston while the floating piston axially moves within the duct

As shown in FIG. 10, the PX 1000 may include a rotor 1002. The rotor may be configured to rotate about a central axis of the PX 1000. The PX 1000 may further include a motor assembly coupled to the rotor. The motor assembly may drive the rotation of the rotor. As will be discussed further in other embodiments, the rotor 1002 may include a cylindrical structure forming a series of vanes disposed on a circumference of the cylindrical structure.

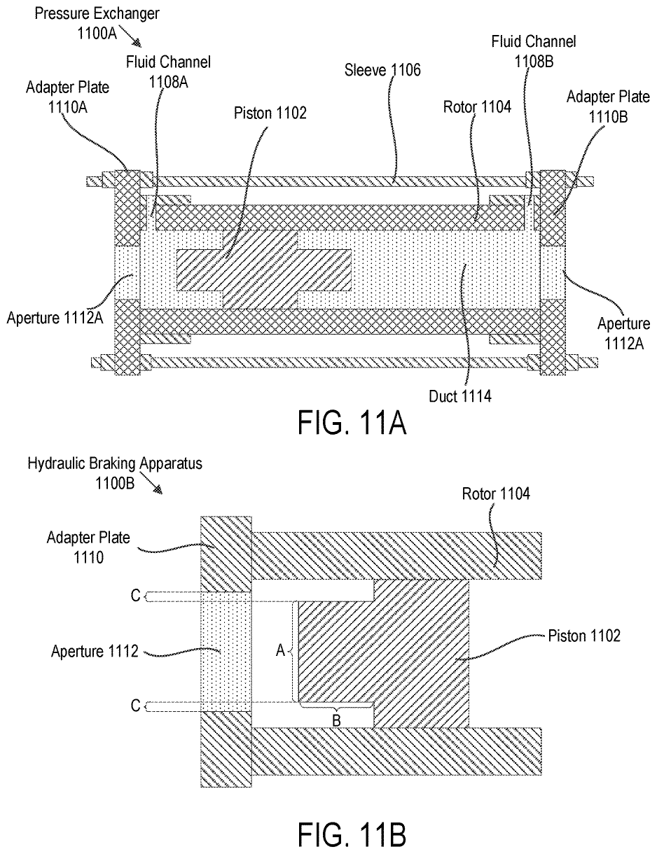

FIG. 11A-B illustrates a pressure exchanger (PX) 1100A (or LPC) including a hydraulic braking apparatus 1100B, according to some embodiments. The PX 1100A may include a rotor 1104 with a duct 1114 disposed within a sleeve 1106. The rotor may be enclosed by a first adapter plate 1110A and a second adapter plate 1110B. The rotor 1104 may rotate about a central axis of the pressure exchanger 1100A. In some embodiments, the PX 1100A may include constraints disposed within the rotor (e.g., barrier ring 910 of FIG. 9A, alternatively the constraints may include retaining rings). The piston may be configured to axially translate within the duct 1114 and may be maintained within the duct by one or more constraints (e.g., adapter plates 1110A-B)

As shown in FIG. 11A-B, the adapter plates 1110A-B include apertures 1112A-B are configured to engage with the piston 1102. The piston 1102 may form a fluid seal with a surface of the duct 1114. The piston may include a cylindrical body configured to form the fluid seal and a nose configured to engage with an aperture 1112A. The nose may comprise one or more widths that are smaller than the cylindrical body.

In some embodiments, the nose of the piston 1102 may include a nose width “A” (e.g., nose diameter), a nose length “B,” and a nose clearance “C.” Various combinations of A, B, C may be utilized for various criteria of the species fluid used for pressure exchange. For example, the flow rate, velocity, density, make-up (e.g., proppant or proppant free), pressure, and so on of the incoming fluid can drive the nose geometry and clearance selection. Each of the dimensions A, B, C may be adjusted to alter the braking force applied to the piston as the piston approaches the aperture 1112.

In some embodiments, the hydraulic braking apparatus 1100B may be included on both ends of the duct 1114 and perform bidirectional braking of the piston 1102 as it reaches both ends of the rotor. In some embodiments, as the piston 1102 approaches an adapter plate (e.g., adapter plate 1110A), the piston forms a pocket of fluid between the piston 1102, the adapter plate 1110A, and a surface of the duct 1114. The pocket of fluid decreases in volume as the piston approaches the adapter plate raising the pressure of the fluid pocket. The increased pressure applies a force (e.g., a braking force or a counter force) countering the motion of the piston 1102 and slows or brakes the speed of the piston. It should be noted that, in some cases, damage and/or wear to a part may occur if the piston contacts the adapter plate at high speeds. The braking apparatus may slow down the piston 1102 and prevent potentially damaging collisions between the piston 1102 and the adapter plate 1110.

In some embodiments, the PX 1100A may include fluid channels 1108A-B fluidly coupled to the ducts. The fluid channels may provide an increased volume to the pockets of fluid formed as the pistons 1102 approach the adapter plates 1110A-B. The fluid channel may control a flow of fluid out of the duct resulting in a controlled pressure of the pocket. The controlled pressure may allow for controlling the magnitude of the braking force applied to the piston 1102 when the piston approaches the adapter plates 1110A-B.

In some embodiments, the piston 1102 forms a fluid seal with the adapter plate such that the pocket formed is hydraulically sealed from the remaining fluid in the duct. However, in other embodiments, there exists a gap or nose clearance “C” between the piston and the aperture 1112 of the adapter plate 1110. The clearance dimension may control and affect a rate of fluid flow out of a fluid pocket constrained between the piston 1102, the surface of the duct 1114, and the adapter plate 1110. This rate of fluid flow out of the fluid pocket may affect the braking force applied to the piston and the overall deceleration of the piston 1102 as it approaches an adapter plate 1110.

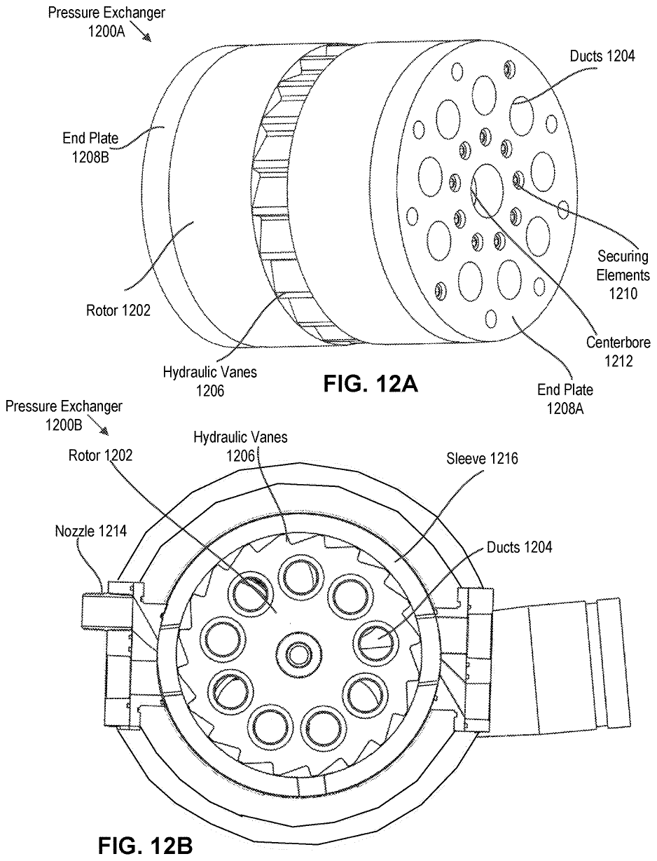

FIG. 12A-B are perspective views of embodiments of a PX 1200A-B (or LPC) including hydraulic vanes 1206 (e.g., vanes, protrusions, etc.), according to certain embodiments. As shown in FIG. 12A, the PX 1200A includes a rotor 1202 that forms one or more ducts 1204. The PX may include end plates 1208A-B coupled to ends of the rotor 1202. In some embodiments, the end plates 1208A-B (e.g., adapter plate 1110 of FIGS. 11A and/or 11B) are secured to the end of the rotor 1202 via securing elements 1210 (e.g., fasteners, adhesives, etc.), however, in other embodiments, the end plates 1208A-B are coupled to the rotor via a friction fit. In some embodiments, pressure exchanger 1200 that has floating pistons in the ducts may use a passive scheme to start the pressure exchanger 1200 (e.g., start or increase rotation of the rotor of the pressure exchanger). Responsive to the rotor 1202 not spinning, one or more valves (e.g., check valves) may provide fluid flow (e.g., divert LP fluid in flow) to the hydraulic drive (e.g., hydraulic vanes 1206) to cause the rotor 1202 to spin. Once the rotor begins to spin and pressure is built up, the one or more valves (e.g., check valves) may prevent fluid flow (e.g., automatically cut off flow) to the hydraulic drive (e.g., hydraulic vanes) and the rotor 1202 continues to spin from hydraulic torque generated by the ramps (e.g., hydraulic vanes 1206).

A first end of the rotor may receive a first fluid, and a second end of the rotor may receive a second fluid. A barrier may be disposed within the ducts 1204 of the rotor 1202 to prevent mixing while exchanging pressure between the first and second fluids.

In some embodiments, the presence of a barrier (e.g., pistons) disposed within the ducts 1204 may present difficulties in initializing rotation of the rotor 1202 to begin the pressure exchange process. In some embodiments, as previously described, a motor may be coupled to the rotor 1202 via a coupling within the centerbore 1212 to drive the rotation of the rotor 1202. However, in other embodiments (e.g., such as those not using a motor), the rotor may include a series of hydraulic vanes 1206 disposed along a circumference of the rotor 1202. The hydraulic vanes 1206 are to receive a fluid and rotate the rotor 1202 responsive to receiving a fluid. In some embodiments, a hydraulic vane 1206 is an angled protrusion of the rotor 1202. Each hydraulic vane 1206 may include an angled upper surface and a side surface. Fluid provided to the hydraulic vanes 1206 may contact the side surfaces of the hydraulic vanes 1206 to cause rotation of the rotor 1202.

As shown in FIG. 12A, the hydraulic vanes 1206 may be disposed along a circumference of the rotor 1202. The hydraulic vane 1206 may comprise a portion of the axial length. In some embodiments, the hydraulic vanes 1206 may comprise an entire axial length of the rotor 1202. The vane provides a contact surface to receive a pressurized fluid (e.g., a third fluid that may include a portion of the first and/or second fluids). The force applied to the vane causes a rotation force to be applied to the rotor 1202. As the rotor 1202 rotates, successive vanes receive an impulse from the incoming fluid and increase the torque on the rotor 1202 within the PX 1200A.

As shown in FIG. 12B, the rotor rotates within a sleeve 1216. The PX 1200B may include a nozzle 1214 that accelerates the incoming fluid and directs the jet onto the vanes to drive the rotation of the rotor. The torque generated and rotational speed of the rotor may be adjusted by controlling the flow rate through the nozzle by means of an upstream valve. Once the rotor begins to rotate, the moveable barrier disposed within the ducts 1204 begins to reciprocate, causing the flow rate of the first and second fluids (which exchange pressure) to increase. If the end covers directing the first and second fluids into the rotor have suitable ramps (to generate a torque on the rotor) as the fluids enter the rotor duct, there may no longer be a need for the nozzle flow to continue rotating the rotor. Hence flow to the nozzle and hydraulic vanes may be halted. In some embodiments, once the rotor has attained a desired speed, the nozzle may close, and the rotor may maintain speed without the presence of a rotation driving fluid.

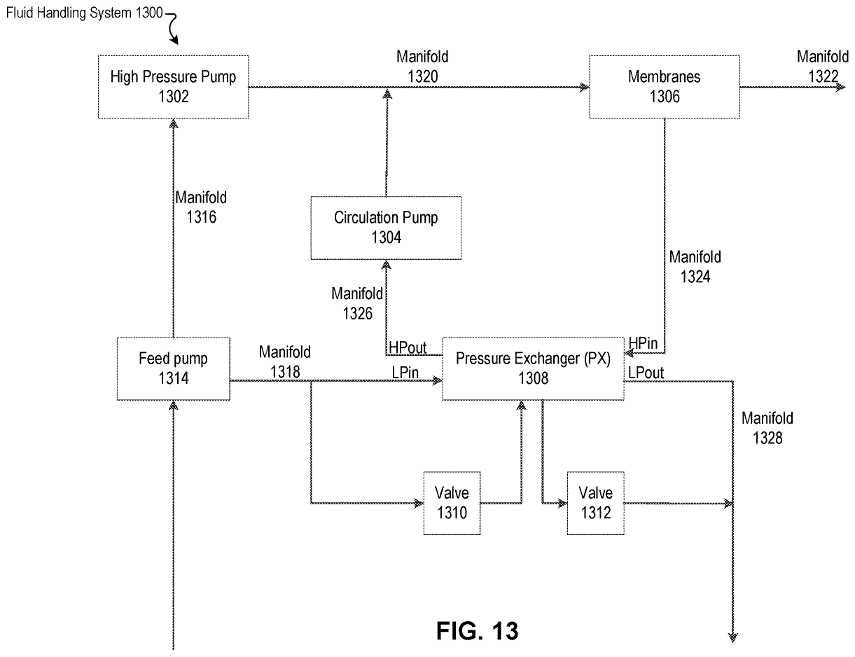

FIG. 13 illustrates a schematic diagram of a fluid handling system 1300 (e.g., reverse osmosis desalination system) using a reduced mixing pressure exchanger 1308, according to certain embodiments. The fluid handling system 1300 further includes a feed pump 1314 (e.g., a low-pressure pump) for pumping feed-water into the fluid handling system 1300. A high-pressure pump 1302 provides high-pressure feed-water to a membrane separation device configured for separating (e.g., desalinating) fluids traversing a membrane 1306 (e.g., reverse osmosis membrane). Concentrated feed-water or concentrate from the membrane 1306 (e.g., membrane separation device) may be provided to the pressure exchanger 1308. An example of a concentrate is brine. Pressure in the concentrate may be used in the pressure exchanger 1308 to compress low-pressure feed-water to high-pressure feed-water. For simplicity and illustration purposes, the term feed water is used in the detailed description. However, fluids other than water may be used in the pressure exchanger 1308.

The feed pump 1314 may receive feed-water from a reservoir or directly from the ocean and pump the feed-water at low pressure into the fluid handling system 1300. Low-pressure feed-water may be provided to the high-pressure pump 1302 via manifold 1316 and the pressure exchanger 1308 via manifold 1318. High-pressure feed-water may be provided to the membrane 1306 (e.g., membrane separation device) via manifold 1320. The membrane may separate fresh water for output to manifold 1322 at low pressure.

Concentrate from the membrane 1306 (e.g., membrane separation device) may be provided to the pressure exchanger 1308 via manifold 1324. The pressure exchanger 1308 may use high-pressure concentrate from manifold 1324 to compress (or exchange pressure with) low-pressure feed-water from manifold 1318. The compressed feed-water may be provided to the membrane 1306 (e.g., membrane separation device) via manifold 1326, which is coupled to manifold 1320. The pressure exchanger 1308 may output concentrate at low pressure via manifold 1328. Thus, concentrate that has given up pressure to the feed-water may be output from the pressure exchanger 1308 at low pressure to manifold 1328. The low-pressure concentrate in manifold 1328 may be discarded, e.g., released for return to the sea. In some embodiments, the high-pressure feed-water is output from the pressure exchanger 1308 to manifold 1326 at a slightly lower pressure than the high-pressure feed-water in manifold 1320. An optional circulation pump 1304 may make up the small difference in pressure between feed-water in manifold 1326 and manifold 1320. In some embodiments, the circulation pump 1304 is a rotodynamic device (e.g., centrifugal pump). Table 1 provides an example of some typical pressures in a desalination system (e.g., illustrated in FIG. 13, illustrated in FIG. 1C, etc.).

TABLE 1

| High-Pressure | Low- | High- | High- | Low- |
|---|---|---|---|---|
| Pump- | Pressure | Pressure | Pressure | Pressure |
| Membrane | Feed-water | Feed-water | Concentrate | Concentrate |
| Manifold | Manifold | Manifold | Manifold | Manifold |
| 1320 | 1318 | 1326 | 1324 | 1328 |
| 1,000 PSI | 30 PSI | 965 PSI | 980 PSI | 15 PSI |

In the example illustrated by Table 1, the pressure exchanger 1308 receives low-pressure feed-water at about 30 pounds per square inch (PSI) and receives high-pressure brine or concentrate at about 980 PSI. The pressure exchanger 1308 transfers pressure from the high-pressure concentrate to the low-pressure feed-water. The pressure exchanger 1308 outputs high pressure (compressed) feed-water at about 965 PSI and low-pressure concentrate at about 15 PSI. Thus, the pressure exchanger 1308 of Table 1 may achieve high pressure exchange efficiencies around 97%

As shown in FIG. 13, the fluid handling system 1300 (e.g., desalination system) may include an additional flow path from manifold 1318 to the pressure exchanger. Low-pressure feed-water may be directed to a check valve 1310. In some embodiments, the check valve 1310 is one or more of a spring-loaded valve, a ball check valve, a dual plate valve, a disc valve, or other check valves that fulfill an equitable purpose. The low pressure feed-water may be admitted through the check valve 1310 to the pressure exchanger 1308. The check valve 1310, in operation, allows flow in only one direction-from manifold 1318 to pressure exchanger 1308. The low pressured feed-water from the check valve 1310 may contact a rotor of the pressure exchanger 1308 and cause rotational motion of the pressure exchanger 1308. For example, the pressure exchanger may include contact points (e.g., hydraulic vanes 1206 of FIGS. 12A-B) that are configured to receive an impulse from the low pressured feed-water and cause rotational motion of the pressure exchanger 1308. In some embodiments, the impulse from the low pressured feed-water is to initialize and/or maintain rotation of the pressure exchanger 1308. In some embodiments, the check valve 1310 is normally closed and is opened when a pressure differential across the check valve 1310 exceeds a threshold condition.

As shown in FIG. 13, the fluid handling system 1300 (e.g., desalination system) may include an output flow path from the pressure exchanger 1308 that includes a check valve 1312. In some embodiments, the check valve 1312 is one or more of a spring-loaded valve, a ball check valve, a dual plate valve, a disc valve, or other check valves that fulfill an equitable purpose. The low pressured feed-water may be admitted through the check valve 1312 from the pressure exchanger 1308 to manifold 1328. The check valve 1312, in operation, allows flow only in one direction-from the pressure exchange 1308 to manifold 1328. In some embodiments, the check valve 1312 is normally open and is closed when a pressure differential across the check valve 1312 exceeds a threshold condition.

In some embodiments, operation of the fluid handling system 1300 may include the following operational steps. The feed pump 1314 may be initialized and begin pumping feed water. Responsive to feed pump initialization, the floating pistons disposed within the pressure exchanger 1308 moves to the right end and blocks feed pump flow. The operation further includes opening a first spring-loaded check valve 1310 (upon exceeding a threshold pressure differential) and diverting low pressure input fluid (LPin) to the hydraulic drive of the pressure exchanger 1308. Responsive to the check valve 1310 opening, and the fluid entering the hydraulic drive (jets from nozzle impinging on rotor vanes) the rotor begins to spin. The operation further includes opening a second spring-loaded check valve 1312 (e.g., normally open), collecting LPin flow, and diverting the LPin flow to low pressure output flowpath (LPout) from the PX 1308. Once the rotor attains a certain speed, the circulation pump is initialized and the pistons begin to reciprocate within the pressure exchanger 1308. Once the flow begins to pass through rotor ducts of the pressure exchanger 1308, check valves 1310, 1312 will close (e.g., automatically) and the hydraulic drive ceases of function. Rotor speed is maintained by the hydraulic torque generated by the ramps feeding the PX flows. The high-pressure pump is initialized and permeate production begins (e.g., steady-state operation).

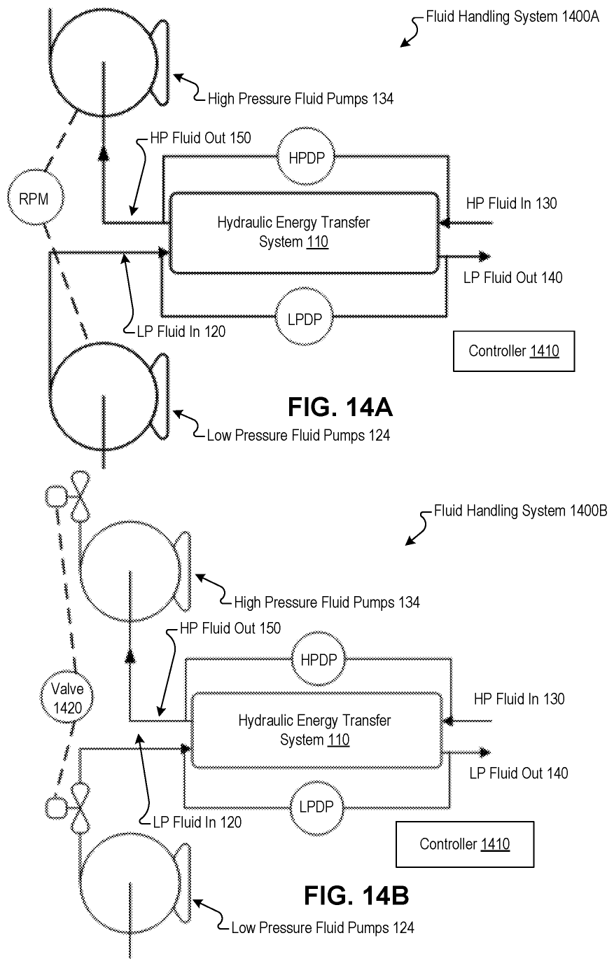

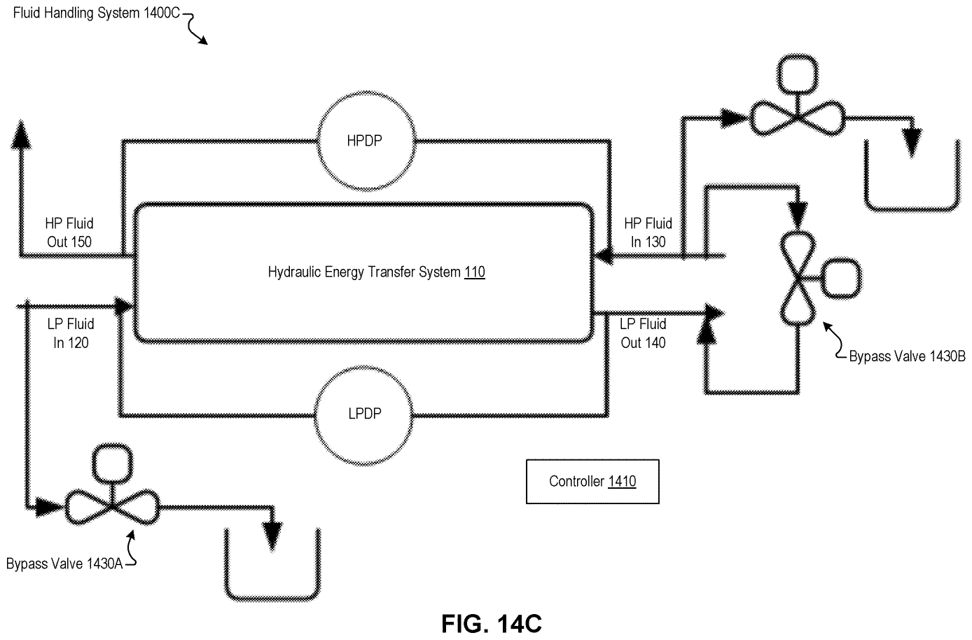

FIGS. 14A-C illustrate fluid handling systems 1400A-C (e.g., one or more of FIGS. 1A-D and/or FIG. 13), according to certain embodiments. One or more of FIGS. 1A-D, 13, and/or 14A-C may have one or more features, components, functionalities, etc. as one or more of FIGS. 1A-D, 13, and/or 14A-C. For example, one or more of FIGS. 1A-D and/or 13 may have a controller 1410 of one or more of FIGS. 14A-C.

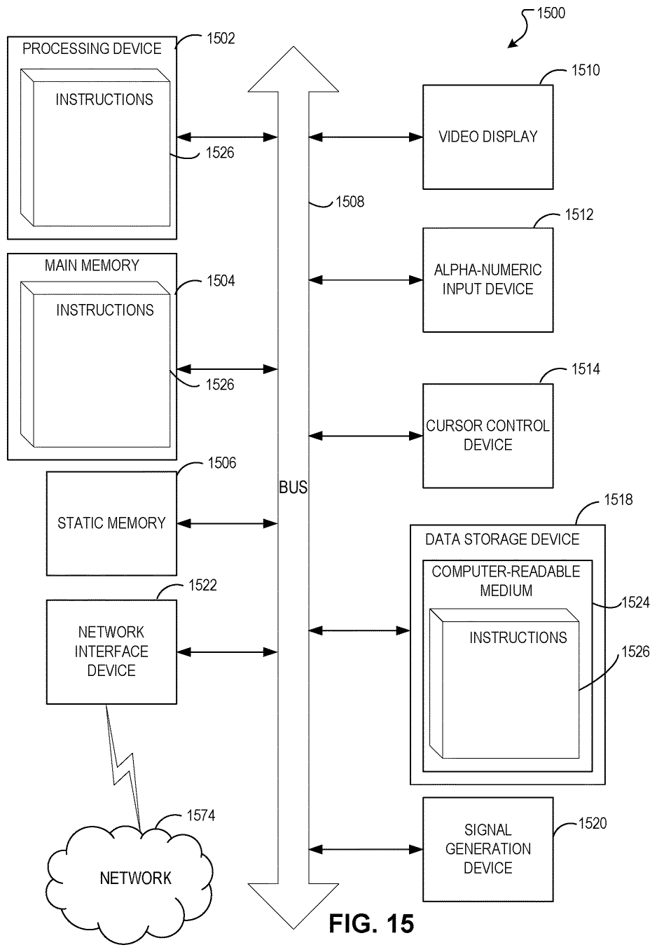

Each of fluid handling systems 1400A-C include a hydraulic energy transfer system 110 which may have reduced mixing (e.g., include pistons) as described herein. Each of fluid handling systems 1400A-C may include a controller 1410 (e.g., computer system 1500 of FIG. 15). Each of fluid handling systems 1400A-C may include one or more high pressure fluid pumps 134 and one or more low pressure fluid pumps 124. HP fluid in 130 and LP fluid in 120 enter the hydraulic energy transfer system 110 (e.g., pressure exchanger), pressure is transferred, the HP fluid in 130 exits as LP fluid out 140, and LP fluid in 120 exits as HP fluid out 150

In some embodiments, pistons in the hydraulic energy transfer system 110 (e.g., in the ducts of the rotor of the pressure exchanger) provide a balanced flow in the fluid handling system 1400 (e.g., in the pressure exchanger). Mismatches in high-pressure pumping and low-pressure pumping or low speed (e.g., revolutions per minute (RPM)) cause pressure rise across the piston. Differential pressure (DP) across pistons is transferred via hydraulic brake which contacts the rotor and contributes to axial bearing loading. Excessive DP may cause stalling if the thrust load exceeds bearing capacity.

In some embodiments, controller 1410 determines DP (e.g., high pressure DP (HPDP) and/or low pressure DP (LPDP)) based on sensor data. In some embodiments, controller 1410 determines HPDP based on sensors at HP fluid in 130 and/or HP fluid out 150. In some embodiments, controller 1410 determines HPDP based on a sensor disposed in piping that is routed between HP fluid in 130 and HP fluid out 150. In some embodiments, controller 1410 determines LPDP based on sensors at LP fluid in 120 and/or LP fluid out 140. In some embodiments, controller 1410 determines LPDP based on a sensor disposed in piping that is routed between LP fluid in 120 and LP fluid out 140.

Referring to FIG. 14A, in some embodiments, controller 1410 determines DP (e.g., HPDP and/or LPDP) based on sensor data and the controller 1410 reduces pump RPM responsive to the DP meeting a threshold value (e.g., HPDP exceeding a first threshold value and/or LPDP exceeding a second threshold value). In some embodiments, controller 1410 determines RPM based on sensor data (e.g., sensor data from high pressure fluid pumps 134 and/or low pressure fluid pumps 124). In some embodiments, controller 1410 causes the RPMs of high pressure fluid pumps 134 and low pressure fluid pumps 124 to be adjusted (e.g., by transmitting instructions to high pressure fluid pumps 134 and low pressure fluid pumps 124).

Referring to FIG. 14B, in some embodiments, controller 1410 determines DP based on sensor data and the controller 1410 actuates (e.g., modulates valve position) one or more valves 1420 responsive to the corresponding DP meeting a threshold value (e.g., exceeding a threshold value).

Referring to FIG. 14C, in some embodiments, controller 1410 determines DP based on sensor data and the controller 1410 causes bypass flow via one or more bypass valves 1430 responsive to the corresponding DP exceeding a threshold value. In some embodiments, controller 1410, based on sensor data (e.g., HPDP, LPDP, etc.), actuates bypass valve 1430A to provide LP fluid in 120 bypass to somewhere else (e.g., to a reservoir, to LP fluid source, etc.). In some embodiments, controller 1410, based on sensor data (e.g., HPDP, LPDP, etc.), actuates bypass valve 1430B to provide HP fluid in 130 bypass to LP fluid out 140.

FIG. 15 is a block diagram illustrating a computer system 1500, according to certain embodiments. In some embodiments, the computer system 1500 is a client device. In some embodiments, the computer system 1500 is a controller device (e.g., server, controller 1410 of FIGS. 14A-C, client device, etc.).

In some embodiments, computer system 1500 is connected (e.g., via a network, such as a Local Area Network (LAN), an intranet, an extranet, or the Internet) to other computer systems. Computer system 1500 operates in the capacity of a server or a client computer in a client-server environment, or as a peer computer in a peer-to-peer or distributed network environment. In some embodiments, computer system 1500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In some embodiments, the computer system 1500 includes a processing device 1502, a volatile memory 1504 (e.g., Random Access Memory (RAM)), a non-volatile memory 1506 (e.g., Read-Only Memory (ROM) or Electrically-Erasable Programmable ROM (EEPROM)), and/or a data storage device 1516, which communicates with each other via a bus 1508.

In some embodiments, processing device 1502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor). In some embodiments, processing device 1502 is provided by one or more of a single processor, multiple processors, a single processor having multiple processing cores, and/or the like.

In some embodiments, computer system 1500 further includes a network interface device 1522 (e.g., coupled to network 1574). In some embodiments, the computer system 1500 includes one or more input/output (I/O) devices. In some embodiments, computer system 1500 also includes a video display unit 1510 (e.g., a liquid crystal display (LCD)), an alphanumeric input device 1512 (e.g., a keyboard), a cursor control device 1514 (e.g., a mouse), and/or a signal generation device 1520.

In some implementations, data storage device 1518 (e.g., disk drive storage, fixed and/or removable storage devices, fixed disk drive, removable memory card, optical storage, network attached storage (NAS), and/or storage area-network (SAN)) includes a non-transitory computer-readable storage medium 1524 on which stores instructions 1526 encoding any one or more of the methods or functions described herein, and for implementing methods described herein.

In some embodiments, instructions 1526 also reside, completely or partially, within volatile memory 1504 and/or within processing device 1502 during execution thereof by computer system 1500, hence, volatile memory 1504 and processing device 1502 also constitute machine-readable storage media, in some embodiments.

While computer-readable storage medium 1524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless U specifically stated otherwise, terms such as “actuating,” “adjusting,” “causing,” “controlling,” “determining,” “identifying,” “providing,” “receiving,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The preceding description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

It should be noted the valve system (e.g., check valve 1310, check valve 1312) is described in the context of a desalination system in some embodiments. However, analogous valve systems may be used in other applications of the pressure exchanger 1308. For example, the valve system may be incorporated into fluid handling systems include fracking systems and refrigeration systems, as described herein.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about,” “substantially,” or “approximately” is used herein, this is intended to mean that the nominal value presented is precise within +10%. Also, the terms “first,” “second,” “third,” “fourth,” etc. as used herein are meant as labels to distinguish among different elements and can not necessarily have an ordinal meaning according to their numerical designation.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner. In one embodiment, multiple metal bonding operations are performed as a single step.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which each claim is entitled.

What is claimed is:

1. A pressure exchanger configured to exchange pressure between a first fluid and a second fluid, the pressure exchanger comprising:
a rotor configured to rotate about a central axis, wherein the rotor forms a duct from a first duct opening formed by the rotor to a second duct opening formed by the rotor, wherein the pressure exchanger is configured to direct the first fluid to the first duct opening and the second fluid to the second duct opening;
a floating piston disposed within the duct, wherein the floating piston is configured to form a barrier within the duct to prevent mixing of the first fluid and the second fluid and to cause the pressure exchange between the first fluid and the second fluid, and wherein the floating piston comprises an axially symmetric structure configured to axially slide within the duct;
a first constraint structure disposed within the duct proximate the first duct opening, wherein the first constraint structure is configured to prevent the floating piston from exiting the duct; and
a second constraint structure disposed proximate the second duct opening, wherein the second constraint structure is configured to prevent the floating piston from exiting the duct, and wherein at least one of the first constraint structure or the second constraint structure is: press fit in the duct; shrunk fit in the duct; or restrained in the duct between corresponding retaining rings or between a corresponding retaining ring and a corresponding duct sidewall of the rotor, wherein the floating piston further comprises:
a cylindrical body;
a first nose surface at a first distal end of the cylindrical body configured to engage with the first constraint structure; and
a second nose surface at a second distal end of the cylindrical body configured to engage with the second constraint structure.

2. The pressure exchanger of claim 1, wherein:
responsive to being proximate the first constraint structure, the floating piston forms a sealed pocket of fluid between the floating piston, a duct surface of the rotor, and the first constraint structure; and
pressure in the sealed pocket of fluid is configured to increase in proportion to piston velocity of the floating piston to cause a braking force to be applied to the floating piston while the floating piston axially moves within the duct.

3. The pressure exchanger of claim 1, wherein:
responsive to the rotor not spinning, one or more valves are to provide fluid flow to a hydraulic drive of the rotor to cause the rotor to spin; and
responsive to the rotor spinning, the one or more valves are to prevent the fluid flow to the hydraulic drive.

4. A hydraulic energy transfer system comprising:
a pressure exchanger configured to exchange pressure between a first fluid and a second fluid, the pressure exchanger comprising:
a rotor forming a duct from a first duct opening formed by the rotor to a second duct opening formed by the rotor, the first duct opening and the second duct opening having a first opening width, wherein the pressure exchanger is configured to direct the first fluid to the first duct opening and the second fluid to the second duct opening;
a floating piston disposed within the duct, wherein the floating piston is configured to move within the duct between the first duct opening and the second duct opening to prevent mixing of the first fluid and the second fluid while exchanging the pressure between the first fluid and the second fluid within the duct;
a first adapter plate disposed proximate the first duct opening, wherein the first adapter plate is configured to prevent the floating piston from exiting the duct at the first duct opening, and wherein the first adapter plate forms a first aperture that directs the first fluid to the first duct opening; and
a second adapter plate disposed proximate the second duct opening, wherein the second adapter plate is configured to prevent the floating piston from exiting the duct at the second duct opening, and wherein the second adapter plate forms a second aperture that directs the second fluid to the second duct opening, wherein the floating piston further comprises:
a cylindrical body;
a first curved contact surface disposed on a first end of the cylindrical body configured to engage with the first adapter plate; and
a second curved contact surface disposed on a second end of the cylindrical body configured to engage with the second adapter plate.

5. The hydraulic energy transfer system of claim 4, wherein the cylindrical body further comprises:
a first portion having a first body width;
a second portion having the first body width; and
a third portion disposed between the first portion and the second portion, the third portion having a second body width that is less than the first body width.

6. The hydraulic energy transfer system of claim 4, wherein the first aperture has a first aperture width, wherein the first opening width of the first duct opening is larger than the first aperture width, and wherein the floating piston comprises:
a first portion forming a fluid seal within the duct, the first portion having a first portion width substantially equal to the first opening width; and
a second portion having a second portion width smaller than the first opening width, wherein the second portion is configured to fit within the first aperture.

7. The hydraulic energy transfer system of claim 6, wherein:
responsive to being in a first position, the first portion of the floating piston forms a sealed pocket of fluid between the floating piston, a surface of the duct, and the first adapter plate; and
a braking force is to be applied to the floating piston responsive to the floating piston approaching the first duct opening.

8. The hydraulic energy transfer system of claim 4, further comprising a motor assembly coupled to the rotor, wherein the motor assembly is configured to drive rotation of the rotor.

9. The hydraulic energy transfer system of claim 4, wherein the rotor further comprises a cylindrical structure forming a series of vanes disposed on a circumference of the cylindrical structure.

10. The hydraulic energy transfer system of claim 9, further comprising:
a high-pressure pump configured to pump the first fluid, wherein the pressure exchanger is configured to receive the first fluid from the high-pressure pump, wherein a first portion of the first fluid is to be provided from the high-pressure pump to the first duct opening, and wherein a second portion of the first fluid is to be provided from the high-pressure pump to the series of vanes to cause rotation of the rotor about a central axis of the pressure exchanger; and
a low-pressure pump configured to pump the second fluid, wherein the pressure exchanger is configured to receive the second fluid from the low-pressure pump.
